(19) United States
(12) Patent Application Publication
(10) Pub. No.: US 2024/0329552 A1
(43) Pub. Date: Oct. 3, 2024

(54) ELECTROSTATIC IMAGE DEVELOPING TONER, ELECTROSTATIC IMAGE DEVELOPER, AND TONER CARTRIDGE

(71) Applicant: FUJIFILM Business Innovation Corp., Tokyo (JP)

(72) Inventors: Eiji KAWAKAMI, Kanagawa (JP); Shinya SAKAMOTO, Kanagawa (JP); Daisuke ISHIZUKA, Kanagawa (JP)

(73) Assignee: FUJIFILM Business Innovation Corp., Tokyo (JP)

(21) Appl. No.: 18/461,907

(22) Filed: Sep. 6, 2023

(30) Foreign Application Priority Data
Mar. 28, 2023 (JP) 2023-052434

(51) Int. Cl. G03G 9/087; G03G 9/08

(52) U.S. Cl. CPC G03G 9/08755; G03G 9/0819; G03G 9/08711; G03G 9/08795; G03G 9/08797

(57) ABSTRACT

An electrostatic image developing toner includes toner particles including a binder resin and vinyl resin particles. When a cross section of the toner particles is observed and the areas Sa [μm²] of Voronoi polygons obtained by Voronoi division of the cross section using geometric centers of the vinyl resin particles as generatrices are measured, Formulae (1) and (2) are satisfied: 0.03≤Sac≤0.20 (1), Ssd≤0.10 (2), where Sac and Ssd represent the median [μm²] and the standard deviation [μm²] of the areas Sa of the Voronoi polygons, respectively.

### CROSS-REFERENCE TO RELATED APPLICATIONS

This application is based on and claims priority under 35 USC 119 from Japanese Patent Application No. 2023-052434 filed Mar. 28, 2023.

### BACKGROUND

### (i) Technical Field

The present disclosure relates to an electrostatic image developing toner, an electrostatic image developer, and a toner cartridge.

### (ii) Related Art

Japanese Unexamined Patent Application Publication No. 2016-062040 discloses an electrostatic image developing toner that includes toner particles including a binder resin including a polyester resin, a release agent including a hydrocarbon wax, and a styrene (meth)acrylic resin. The amount of release agent present in a region that extends from the surfaces of the toner particles to a depth of 800 nm is 70% or more of the total amount of release agent. In the toner particles, the styrene (meth)acrylic resin forms domains having an average diameter of 0.3 μm or more and 0.8 μm or less. The proportion of the number of the domains having a size that falls within the range of the average diameter plus or minus 0.1 μm is 65% or more.

Japanese Unexamined Patent Application Publication No. 2016-062042 discloses an electrostatic image developing toner that includes toner particles including a binder resin including a polyester resin, a release agent including a hydrocarbon wax, and a styrene (meth)acrylic resin. The amount of release agent present in a region that extends from the surfaces of the toner particles to a depth of 800 nm is 70% or more of the total amount of release agent. In the toner particles, the styrene (meth)acrylic resin forms domains having an average diameter of less than 0.3 μm.

Japanese Unexamined Patent Application Publication No. 2020-046499 discloses an electrostatic image developing toner that includes a binder resin and rubber particles. The compression set of the rubber particles which is measured at a temperature at which the melt viscosity of the toner reaches 104 Pa is 20% or more and 50% or less.

Japanese Unexamined Patent Application Publication No. 2020-160204 discloses an electrostatic image developing toner that contains at least a binder resin and includes a continuous phase including the binder resin and a discontinuous phase included in the continuous phase in a scattered manner, the discontinuous phase including a coating layer that covers the core including the binder resin and includes the binder resin.

### SUMMARY

Aspects of non-limiting embodiments of the present disclosure relate to an electrostatic image developing toner that may limit a reduction in fine-line resolution that occurs when images are repeatedly formed in a high temperature-high humidity environment, compared with an electrostatic image developing toner that includes toner particles including a binder resin, a colorant, and vinyl resin particles, wherein, when a cross section of the toner particles is observed and areas Sa [μm²] of Voronoi polygons obtained by Voronoi division of the cross section using geometric centers of the vinyl resin particles as generatrices are measured, Formulae (1) and (2) below are not satisfied, where Sac and Ssd represent a median [μm²] and a standard deviation [μm²] of the areas Sa of the Voronoi polygons, respectively. Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic image developing toner including toner particles including a binder resin and vinyl resin particles, wherein, when a cross section of the toner particles is observed and the areas Sa [μm²] of Voronoi polygons obtained by Voronoi division of the cross section using geometric centers of the vinyl resin particles as generatrices are measured, Formulae (1) and (2) are satisfied:

$$0.03 \leq Sac \leq 0.2 \qquad ( 1 )$$

$$Ssd \leq 0.1 \qquad ( 2 )$$

where Sac and Ssd represent the median [μm²] and the standard deviation [μm²] of the areas Sa of the Voronoi polygons, respectively.

### BRIEF DESCRIPTION OF THE DRAWINGS

Exemplary embodiments of the present disclosure will be described in detail based on the following figures, wherein:

FIG. 1 is a schematic diagram illustrating an image forming apparatus according to an exemplary embodiment; and

FIG. 2 is a schematic diagram illustrating a process cartridge according to an exemplary embodiment.

### DETAILED DESCRIPTION

Exemplary embodiments of the present disclosure are described below. It should be noted that the following description and Examples are intended to be illustrative of the exemplary embodiments but not restrictive of the scope of the present disclosure.

In the present disclosure, when numerical ranges are described in a stepwise manner, the upper or lower limit of a numerical range may be replaced with the upper or lower limit of another numerical range, respectively. In the present disclosure, the upper and lower limits of a numerical range may be replaced with the upper and lower limits described in Examples below.

Each of the components may include a plurality of substances.

In the present disclosure, in the case where a composition includes a plurality of types of substances that correspond to a component of the composition, the content of the component in the composition is the total content of the substances in the composition unless otherwise specified.

The term “step” used herein refers not only to an individual step but also to a step that is not distinguishable from other steps but achieves the intended purpose of the step.

### Electrostatic Image Developing Toner

An electrostatic image developing toner according to this exemplary embodiment (hereinafter, the electrostatic image developing toner is also referred to simply as “toner”) includes toner particles that include a binder resin and vinyl resin particles.

When a cross section of the toner particles is observed and the areas Sa [μm²] of Voronoi polygons obtained by Voronoi division of the cross section using geometric centers of the vinyl resin particles as generatrices are measured, Formulae (1) and (2) below are satisfied, where Sac and Ssd represent the median [μm²] and the standard deviation [μm²] of the areas Sa of the Voronoi polygons, respectively.

The toner according to this exemplary embodiment may limit a reduction in fine-line resolution that occurs when images are repeatedly formed in a high temperature-high humidity environment (e.g., at 28° C. and 85% RH). The reasons are presumably as follows.

With a demand for an increase in image quality and an increase in the variety of service conditions, there has been further demands for maintaining high-definition image quality with little influence of service conditions even when images are repeatedly formed.

One of the demands is to limit a reduction in fine-line resolution that occurs when images are repeatedly formed in a high temperature-high humidity environment.

In the case where images are repeatedly formed, the amount of toner consumed by the developing device is small and the amount of additional toner fed to the developing device is small accordingly. Thus, the toner included in the developing device is kept subjected to a mechanical load caused as a result of the toner being stirred for charging. This increases the likelihood of the toner particles being cracked or chipped.

A technique in which internal additive particles, such as resin particles or rubber particles, are added to toner particles or the strength of toner particles is increased by forming a sea-island structure using two types of bonder resins, in order to reduce the likelihood of the toner particles being cracked or chipped due to the mechanical load, is known.

Although the occurrence of cracking or chipping of the above toner particles is reduced, the fine-line resolution may become degraded. In toner particles including internal additive particles or toner particles having a sea-island structure, the degree of dispersion of the internal additive particles or island portions of the sea-island structure is low and the “center of mass” and “geometric center” of each of the toner particles do not coincide with each other.

Consequently, when images are repeatedly formed in a high temperature-high humidity environment, external additive particles are likely to be buried in the toner particles due to the mechanical load. If the external additive particles are buried in the toner particles, the amount of charge stored in the toner is reduced and the electrostatic adhesive force is reduced. In the case where the amount of charge stored in the toner is reduced and the “center of mass” and “geometric center” of each of the toner particles do not coincide with each other and off-center occurs, toner particles present at the edges of a toner image formed on an intermediate transfer body or a recording medium are likely to slightly move while rolling thereon. This may reduce fine-line resolution. For example, relative to 20 μm of the width of the finest line that can be formed using an image forming apparatus with a resolution of 1200 dpi, the distance a toner particle having a diameter of 5.2 μm travels while it rolls a half-turn is 8 μm (=2πr/2=(2×3.14×(5.2/2))/2). Thus, the fine-line resolution may be reduced correspondingly.

On the other hand, the toner according to this exemplary embodiment includes toner particles including a binder resin, a colorant, and vinyl resin particles, wherein, when a cross section of the toner particles is observed and the areas Sa [μm²] of Voronoi polygons obtained by Voronoi division of the cross section using geometric centers of the vinyl resin particles as generatrices are measured, Formulae (1) and (2) below are satisfied, where Sac and Ssd represent the median [μm²] and the standard deviation [μm²] of the areas Sa of the Voronoi polygons, respectively. This makes the resin particles to be dispersed in the toner particles in a nearly homogeneous manner. As a result, the cracking or chipping of the toner particles is reduced, and the likelihood of the “center of mass” and “geometric center” of each of the toner particles not coinciding with each other is reduced. Consequently, even when images are repeatedly formed in a high temperature-high humidity environment and the amount of charge stored in the toner is reduced, the rolling of toner particles present at the edges of a toner image may be reduced.

In toner particles that include rubber particles having rubber elasticity as an internal additive, since the rubber particles have stickiness and do not have an acid value, they have a low affinity for the binder resin of the toner particles and it is difficult to enhance the dispersibility of the rubber particles. Note that the term “rubber particles” used herein refers to particles having rubber elasticity at normal temperature (25° C.), and the term “rubber elasticity” used herein refers to a property of being readily deformed with a small external force, having a high elongation (100% or more), and regaining its original shape substantially in a short time when the external force is removed.

In contrast, since vinyl resin particles have low stickiness and an acid value, they have a high affinity for the binder resin of the toner particles and readily enhance the dispersibility of the rubber particles. Consequently, the resin particles may be dispersed in the toner particles in a nearly homogeneous manner.

It is considered that the toner according to this exemplary embodiment may limit a reduction in fine-line resolution that occurs when images are repeatedly formed in a high temperature-high humidity environment by the above mechanisms.

Details of the toner according to this exemplary embodiment are described below.

The toner according to this exemplary embodiment includes toner particles and, as needed, an external additive.

### Cross Section of Toner Particles

In the toner according to this exemplary embodiment, when a cross section of the toner particles is observed and the areas Sa [μm²] of Voronoi polygons obtained by Voronoi division of the cross section using geometric centers of the vinyl resin particles as generatrices are measured, Formulae (1) and (2) are satisfied:

$$0.03 \leq Sac \leq 0.2 \qquad ( 1 )$$

$$Ssd \leq 0.1 \qquad ( 2 )$$

where Sac and Ssd represent the median [μm²] and the standard deviation [μm²] of the areas Sa of the Voronoi polygons, respectively.

If the median Sac of the areas Sa of the Voronoi polygons is small, the number of the vinyl resin particles included in the toner is excessively large, the likelihood of the vinyl resin particles coming into contact with one another is increased, and the degree of dispersion of the vinyl resin particles is reduced. Consequently, the mismatch between the “center of mass” and “geometric center” of each of the toner particles is increased and off-center occurs. If the median Sac of the areas Sa of the Voronoi polygons is large, the number of the vinyl resin particles included in the toner is small, and the degree of dispersion of the vinyl resin particles is reduced. Consequently, the mismatch between the “center of mass” and “geometric center” of each of the toner particles is increased and off-center occurs.

If the standard deviation Ssd of the areas Sa of the Voronoi polygons is large, the mismatch between the “center of mass” and “geometric center” of each of the toner particles is increased and off-center occurs.

Accordingly, when Formulae (1) and (2) are satisfied, even when images are repeatedly formed in a high temperature-high humidity environment, the rolling of toner particles present at the edges of a toner image may be reduced and, consequently, the reduction in fine-line resolution may be limited.

In The toner according to this exemplary embodiment, Formulae (11) and (21) are preferably satisfied, and Formulae (12) and (22) below are more preferably satisfied.

$$0.08 \leq Sac \leq 0.16 \qquad ( 11 )$$

$$Ssd \leq 0. 7 \qquad ( 21 )$$

The median Sac and standard deviation Ssd of the areas Sa of the Voronoi polygons are measured in the following manner.

First, Voronoi polygon division is performed using the centers of gravity of all the vinyl resin particles present in a region of a toner particle as generatrices (i.e., for each of the straight-line segments that connect a pair of adjacent generatrices to each other, a perpendicular bisector is drawn to divide the nearest neighbor region of each generatrix), and the areas Sa of all the resulting Voronoi polygons are measured.

Specifically, the toner is buried in an embedding resin and a slice having a thickness of 0.2 μm or more and 0.3 μm or less is prepared with a cryotome. After an observation surface of the slice has been stained with ruthenium tetroxide, an image of the observation surface is taken with a scanning electron microscope (“S-4700” produced by Hitachi High-Technologies Corporation) at a 20,000-fold magnification. The vinyl resin particles may be identified, for example, on the basis of the difference in the ease of staining between the binder resin and the vinyl resin particles. The areas Sa of the Voronoi polygons included in a toner particle is measured in the image using image processing software (“ImageJ” produced by National Institutes of Health of the United States).

The measurement of the areas Sa of the Voronoi polygons is done for 200 toner particles in the above-described manner, and the median Sac and standard deviation Ssd of the areas of the Voronoi polygons are calculated.

The areas Sa of the Voronoi polygons are measured using the image processing software (“ImageJ” produced by National Institutes of Health of the United States) in the following manner.
1. Select “Analyze”→“Set Scale” to define the relationship between the number of pixels in the image and the actual distance (e.g., when 144 pixels corresponds to 1.5 μm, input “Distance in Pixels: 144”, “Known distance: 1.5”, and check the checkbox “Global”).
2. Select “Image”→“Type”→“8-bit”.
3. Select “Image”→“Adjust”→“Threshold”, check “Dark background”, and click the “Auto” button.
4. Select “Process”→“Noise”→“Despeckle” to perform a processing and remove spot-like image noises.
5. Select “Process”→“Binary”→“watershed” to enhance the outline of the vinyl resin microparticles, and divide vinyl resin microparticles that appear to overlap one another.
6. Select “Process”→“Binary”→“Voronoi” to form Voronoi polygons using the “geometric centers” of the vinyl resin microparticles as generatrices.
7. Delete the line segments that are derived from the outermost vinyl resin particles and do not form a Voronoi polygon.
8. Select “Image”→“Type”→“8-bit”.
9. Select “Image”→“Adjust”→“Threshold” to color the sides of the Voronoi polygons in red.
10. Select “Edit”→“Invert” to turn black portions white and vice versa so as to color the sides of the Voronoi polygons in white.
11. Select “Analyze”→“Analyze Particle” (size: 0-Infinity, Circularity: 0.00-1.00, Show: Outlines) to calculate the areas Sa of the Voronoi polygons.

### Area of Vinyl Resin Particles

In the observation of the cross section of the toner particles, the ratio of the area of the vinyl resin particles to the area of the toner particles is preferably more than 0.15 and 0.40 or less, is more preferably 0.20 or more and 0.30 or less, and is further preferably 0.22 or more and 0.28 or less.

When the ratio of the area of the vinyl resin particles is more than 0.15, the cracking or chipping of the toner particles is likely to be reduced. When the ratio of the area of the vinyl resin particles is 0.40 or less, the mismatch between the “center of mass” and “geometric center” of each of the toner particles is not likely to occur and the occurrence of off-center may be reduced. Consequently, the reduction in fine-line resolution may be readily limited.

The area of the vinyl resin particles is measured in the following manner.

As in the method for measuring the areas Sa of the Voronoi polygons, an image in which black portions are turned white and vice versa such that the vinyl resin particles in the cross section of the toner particles are colored in white is prepared. Using the image, the ratio of the area of the vinyl resin particles to the area of the toner particles is calculated. The above operation is done for 200 toner particles, and the arithmetic average thereof is calculated.

Proportion of Number of Vinyl Resin Particles that Appear to Overlap One Another

The ratio of the number of the vinyl resin particles that appear to overlap one another to the total number of all the vinyl resin particles observed is preferably 50 number % or less, is more preferably 45 number % or less, is further preferably 35 number % or less, and is ideally 0 number %.

When the proportion of the number of the vinyl resin particles that appear to overlap one another falls within the above range, the dispersibility of styrene-(meth)acrylate copolymer particles in the toner particles is enhanced, the mismatch between the “center of mass” and “geometric center” of each of the toner particles is not likely to occur, and the occurrence of off-center may be reduced. Consequently, the reduction in fine-line resolution may be readily limited.

The proportion of the number of the vinyl resin particles that appear to overlap one another is determined in the following manner.

As in the method for measuring the areas Sa of the Voronoi polygons, an image in which black portions are turned white and vice versa such that the vinyl resin particles in the cross section of the toner particles are colored in white is prepared. The total number of the vinyl resin particles is counted in the image. The number of vinyl resin particles that appear to overlap one another is also counted. The ratio of the number of vinyl resin particles that appear to overlap one another to the total number of the vinyl resin particles observed is calculated.

The above operation is done for 200 toner particles, and the arithmetic average thereof is calculated.

Proportion of Length of Portion of Outline of Toner Particles which Overlaps Vinyl Resin Particles

In the observation of the cross section of the toner particles, the length of a portion of the outline of the toner particles which overlaps the vinyl resin particles is preferably 5% or less, is more preferably 4% or less, and is further preferably 3.5% or less of the length of the outline of the toner particles. The proportion of the length of the above portion of the outline of the toner particles is ideally 0%.

When the proportion of the length of the above portion of the outline of the toner particles is 5% or less, the amount of the vinyl resin particles exposed at the surfaces of the toner particles may be reduced. This may reduce the likelihood of protrusions being formed in the toner particles as a result of the exposure of the vinyl resin particles and the likelihood of toner particles rolling due to the protrusions. Consequently, the reduction in fine-line resolution may be readily limited.

The proportion of the length of a portion of the outline of the toner particles which overlaps the vinyl resin particles (i.e., the ratio of the length of a portion of the outline of the toner particles which overlaps the vinyl resin particles to the length of the outline of the toner particles) is determined in the following manner.

As in the method for measuring the areas Sa of the Voronoi polygons, an image in which black portions are turned white and vice versa such that the vinyl resin particles in the cross section of the toner particles are colored in white is prepared. Using the image, the proportion of the length of a portion of the outline of the toner particles which overlaps the vinyl resin particles is calculated. The above operation is done for 200 toner particles, and the arithmetic average thereof is calculated.

### Average Equivalent Circle Diameter of Vinyl Resin Particles Observed in Observation of Cross Section of Toner

The average equivalent circle diameter of the vinyl resin particles observed in the observation of the cross section of the toner particles is preferably 400 nm or less and is further preferably 300 nm or less.

When the average equivalent circle diameter of the observed vinyl resin particles is 400 nm or less, the vinyl resin particles have an adequate particle size. In such a case, the cracking or chipping of the toner particles may be reduced. Furthermore, the mismatch between the “center of mass” and “geometric center” of each of the toner particles is not likely to occur, and the occurrence of off-center may be reduced. Consequently, the reduction in fine-line resolution may be readily limited.

In the case where one vinyl resin particle is observed alone, the equivalent circle diameter of the vinyl resin particles is the equivalent circle diameter of the vinyl resin particle. In the case where a plurality of vinyl resin particles appear to overlap one another, the equivalent circle diameter of the vinyl resin particles is the equivalent circle diameter calculated on the basis of the area of the region surrounded by the outline of the vinyl resin particles overlapping one another.

The difference between the average equivalent circle diameter of the vinyl resin particles and the average primary particle size of the vinyl resin particles is preferably 50 nm or less, is more preferably 40 nm or less, and is further preferably 30 nm or less. When the difference between the average equivalent circle diameter of the vinyl resin particles and the average primary particle size of the vinyl resin particles is 50 nm or less, the dispersibility of the styrene-(meth)acrylate copolymer particles in the toner particles is enhanced, the mismatch between the “center of mass” and “geometric center” of each of the toner particles is not likely to occur, and the occurrence of off-center may be reduced. Consequently, the reduction in fine-line resolution may be readily limited.

The average equivalent circle diameter of the vinyl resin particles observed is determined in the following manner.

As in the method for measuring the areas Sa of the Voronoi polygons, an image in which black portions are turned white and vice versa such that the vinyl resin particles in the cross section of the toner particles are colored in white is prepared. Using the image, the average equivalent circle diameter of the vinyl resin particles observed is calculated. The above operation is done for 200 toner particles, and the arithmetic average thereof is calculated.

### Structure of Toner Particles

The toner particles include a binder resin and vinyl resin particles and may include, as needed, a colorant, a release agent, other additives, and the like.

### Binder Resin

Examples of the binder resin include vinyl resins that are homopolymers of the following monomers or copolymers of two or more monomers selected from the following monomers: styrenes, such as styrene, para-chlorostyrene, and α-methylstyrene; (meth)acrylates, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; ethylenically unsaturated nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene.

Examples of the binder resin further include non-vinyl resins, such as epoxy resins, polyester resins, polyurethane resins, polyamide resins, cellulose resins, polyether resins, and modified rosins; a mixture of the non-vinyl resin and the vinyl resin; and a graft polymer produced by polymerization of the vinyl monomer in the presence of the non-vinyl resin.

The above binder resins may be used alone or in combination of two or more.

The binder resin may be a polyester resin.

Examples of the polyester resin include publicly known amorphous polyester resins. As polyester resins, a crystalline polyester resin may be used in combination with an amorphous polyester resin. The proportion of the crystalline polyester resin to the entire binder resin may be 2% by mass or more and 40% by mass or less (preferably 5% by mass or more and 25% by mass or less).

The term “crystalline resin” used herein refers to a resin that exhibits a distinct endothermic peak instead of a step-like endothermic change in DSC, that is, specifically, a resin that exhibits an endothermic peak with a half-width of 10° C. or less at a heating rate of 10° C./min.

The term “amorphous” used herein for resins refers to a property of having a half-width of more than 10° C., a property of exhibiting a step-like endothermic change, or a property of not exhibiting a distinct endothermic peak.

### Amorphous Polyester Resin

Examples of the amorphous polyester resin include condensation polymers of a polyvalent carboxylic acid and a polyhydric alcohol. The amorphous polyester resin may be a commercially available one or a synthesized one.

Examples of the polyvalent carboxylic acid include aliphatic dicarboxylic acids, such as oxalic acid, malonic acid, maleic acid, fumaric acid, citraconic acid, itaconic acid, glutaconic acid, succinic acid, alkenyl succinic acid, adipic acid, and sebacic acid; alicyclic dicarboxylic acids, such as cyclohexanedicarboxylic acid; aromatic dicarboxylic acids, such as terephthalic acid, isophthalic acid, phthalic acid, and naphthalenedicarboxylic acid; anhydrides of these dicarboxylic acids; and lower (e.g., 1 to 5 carbon atoms) alkyl esters of these dicarboxylic acids. Among these polyvalent carboxylic acids, aromatic dicarboxylic acids may be used.

Trivalent or higher carboxylic acids having a crosslinked structure or a branched structure may be used as a polyvalent carboxylic acid in combination with the dicarboxylic acids. Examples of the trivalent or higher carboxylic acids include trimellitic acid, pyromellitic acid, anhydrides of these carboxylic acids, and lower (e.g., 1 to 5 carbon atoms) alkyl esters of these carboxylic acids.

The above polyvalent carboxylic acids may be used alone or in combination of two or more.

Examples of the polyhydric alcohol include aliphatic diols, such as ethylene glycol, diethylene glycol, triethylene glycol, propylene glycol, butanediol, hexanediol, and neopentyl glycol; alicyclic diols, such as cyclohexanediol, cyclohexanedimethanol, and hydrogenated bisphenol A; and aromatic diols, such as bisphenol A-ethylene oxide adduct and bisphenol A-propylene oxide adduct. Among these polyhydric alcohols, for example, aromatic diols and alicyclic diols may be used. In particular, aromatic diols may be used.

Trihydric or higher alcohols having a crosslinked structure or a branched structure may be used as a polyhydric alcohol in combination with the diols. Examples of the trihydric or higher alcohols include glycerin, trimethylolpropane, and pentaerythritol.

The above polyhydric alcohols may be used alone or in combination of two or more.

In the case where the vinyl resin particles are styrene-(meth)acrylate copolymer particles, the amorphous polyester resin may be a condensation polymer of a polyvalent carboxylic acid including isophthalic acid and a polyhydric alcohol. The proportion of the isophthalic acid to the polyvalent carboxylic acid is preferably 10 mol % or more and 50 mol % or less and is more preferably 15 mol % or more and 40 mol % or less. In the case where two or more types of amorphous polyester resins are used in combination, the weighted average of the proportions of the isophthalic acid may fall within the above range.

When the proportion of the isophthalic acid to the polyvalent carboxylic acid falls within the above range, the dispersibility of the styrene-(meth)acrylate copolymer particles in the toner particles is enhanced, the mismatch between the “center of mass” and “geometric center” of each of the toner particles is not likely to occur, and the occurrence of off-center may be reduced. Consequently, the reduction in fine-line resolution may be readily limited. The reasons are presumably as follows.

The benzene ring included in the skeleton of a structure of the amorphous polyester resin which is derived from isophthalic acid and the benzene ring included in the styrene skeleton of the styrene (meth)acrylate copolymer are stabilized due to the π-π stacking therebetween. This enhances the affinity between the polyester and the styrene (meth)acrylate copolymer resin particles, because carbonyl groups of isophthalic acid are attached at the meta-positions and present on one side and the benzene ring of the styrene is likely to approach isophthalic acid. On the other hand, since terephthalic acid, which is one of the polyvalent carboxylic acids having a structure analogous to the isophthalic acid, has carbonyl groups attached at the para-positions, the benzene ring of the styrene is difficult to approach terephthalic acid due to steric hindrance. Thus, terephthalic acid does not enhance the affinity between the amorphous polyester resin and the styrene (meth)acrylate copolymer resin particles. Therefore, when the proportion of the isophthalic acid to the polyvalent carboxylic acid falls within the above range, the dispersibility of the styrene-(meth)acrylate copolymer particles in the toner particles is enhanced and, consequently, the reduction in fine-line resolution may be readily limited.

The glass transition temperature Tg of the amorphous polyester resin is preferably 50° C. or more and 80° C. or less and is more preferably 50° C. or more and 65° C. or less.

The glass transition temperature of the amorphous polyester resin is determined from a differential scanning calorimetry (DSC) curve obtained by DSC. More specifically, the glass transition temperature of the amorphous polyester resin is determined from the “extrapolated glass-transition-starting temperature” according to a method for determining glass transition temperature which is described in JIS K 7121:1987 “Testing Methods for Transition Temperatures of Plastics”.

The weight average molecular weight Mw of the amorphous polyester resin is preferably 5,000 or more and 1,000,000 or less and is more preferably 7,000 or more and 500,000 or less.

The number average molecular weight Mn of the amorphous polyester resin may be 2,000 or more and 100,000 or less.

The molecular weight distribution index Mw/Mn of the amorphous polyester resin is preferably 1.5 or more and 100 or less and is more preferably 2 or more and 60 or less.

The weight average molecular weight and number average molecular weight of the amorphous polyester resin are determined by gel permeation chromatography (GPC). Specifically, the molecular weights of the amorphous polyester resin are determined by GPC using a “HLC-8120GPC” produced by Tosoh Corporation as measuring equipment, a column “TSKgel SuperHM-M (15 cm)” produced by Tosoh Corporation, and a THF solvent. The weight average molecular weight and number average molecular weight of the amorphous polyester resin are determined on the basis of the results of the measurement using a molecular-weight calibration curve based on monodisperse polystyrene standard samples.

The amorphous polyester resin may be produced by any suitable production method known in the related art. Specifically, the amorphous polyester resin may be produced by, for example, a method in which polymerization is performed at 180° C. or more and 230° C. or less, the pressure inside the reaction system is reduced as needed, and water and alcohols that are generated by condensation are removed.

In the case where the raw materials, that is, the monomers, are not dissolved in or miscible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where a monomer having low miscibility is present, a condensation reaction of the monomers with an acid or alcohol that is to undergo a polycondensation reaction with the monomers may be performed in advance and subsequently polycondensation of the resulting polymers with the other components may be performed.

### Crystalline Polyester Resin

Examples of the crystalline polyester resin include condensation polymers of a polyvalent carboxylic acid and a polyhydric alcohol. The crystalline polyester resin may be commercially available one or a synthesized one.

In order to increase ease of forming a crystal structure, a condensation polymer prepared from linear aliphatic polymerizable monomers may be used as a crystalline polyester resin instead of a condensation polymer prepared from polymerizable monomers having an aromatic ring.

Examples of the polyvalent carboxylic acid include aliphatic dicarboxylic acids, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acids, such as dibasic acids (e.g., phthalic acid, isophthalic acid, terephthalic acid, and naphthalene-2,6-dicarboxylic acid); anhydrides of these dicarboxylic acids; and lower (e.g., 1 to 5 carbon atoms) alkyl esters of these dicarboxylic acids.

Trivalent or higher carboxylic acids having a crosslinked structure or a branched structure may be used as a polyvalent carboxylic acid in combination with the dicarboxylic acids. Examples of the trivalent carboxylic acids include aromatic carboxylic acids, such as 1,2,3-benzenetricarboxylic acid, 1,2,4-benzenetricarboxylic acid, and 1,2,4-naphthalenetricarboxylic acid; anhydrides of these tricarboxylic acids; and lower (e.g., 1 to 5 carbon atoms) alkyl esters of these tricarboxylic acids.

Dicarboxylic acids including a sulfonic group and dicarboxylic acids including an ethylenic double bond may be used as a polyvalent carboxylic acid in combination with the above dicarboxylic acids.

The above polyvalent carboxylic acids may be used alone or in combination of two or more.

Examples of the polyhydric alcohol include aliphatic diols, such as linear aliphatic diols including a backbone having 7 to 20 carbon atoms. Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol, and 1,10-decanediol may be used.

Trihydric or higher alcohols having a crosslinked structure or a branched structure may be used as a polyhydric alcohol in combination with the above diols. Examples of the trihydric or higher alcohols include glycerin, trimethylolethane, trimethylolpropane, and pentaerythritol.

The above polyhydric alcohols may be used alone or in combination of two or more.

The content of the aliphatic diols in the polyhydric alcohol may be 80 mol % or more and is preferably 90 mol % or more.

The melting temperature of the crystalline polyester resin is preferably 50° C. or more and 100° C. or less, is more preferably 55° C. or more and 90° C. or less, and is further preferably 60° C. or more and 85° C. or less.

The melting temperature of the crystalline polyester resin is determined from the “melting peak temperature” according to a method for determining melting temperature which is described in JIS K 7121:1987 “Testing Methods for Transition Temperatures of Plastics” using a DSC curve obtained by differential scanning calorimetry (DSC).

The crystalline polyester resin may have a weight average molecular weight Mw of 6,000 or more and 35,000 or less.

The crystalline polyester resin may be produced by any suitable method known in the related art similarly to, for example, the amorphous polyester resin.

The content of the binder resin is, for example, preferably 40% by mass or more and 95% by mass or less, is more preferably 50% by mass or more and 90% by mass or less, and is further preferably 60% by mass or more and 85% by mass or less of the whole amount of the toner particles.

### Vinyl Resin Particles

The vinyl resin particles are resin particles composed of a homopolymer or copolymer of a vinyl monomer.

Examples of the vinyl resin particles include particles of a styrene resin (e.g., polystyrene or α-polymethylstyrene), a (meth)acrylic resin (e.g., polymethyl methacrylate or polyacrylonitrile), and a copolymer thereof. The above resins may be used alone or in a mixture of two or more as needed.

The vinyl resin particles may be styrene-(meth)acrylate copolymer particles in order to enhance the dispersibility of the vinyl resin particles in the toner particles and limit the reduction in fine-line resolution.

The styrene-(meth)acrylate copolymer is, for example, a copolymer produced by at least copolymerization of a styrene monomer and a (meth)acrylic monomer. The styrene-(meth)acrylate resin may be a copolymer produced by copolymerization of a styrene monomer, a (meth)acrylic monomer, and another monomer.

Note that the expressions “(meth)acryl” and the like used herein refer to both “acryl” and the like and “methacryl” and the like.

The styrene monomer is a monomer including a styrene skeleton. Specific examples of the styrene monomer include styrene; vinylnaphthalene; alkyl-substituted styrenes, such as α-methylstyrene, o-methylstyrene, m-methylstyrene, p-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene; aryl-substituted styrenes, such as p-phenylstyrene; alkoxy-substituted styrenes, such as p-methoxystyrene; halogen-substituted styrenes, such as p-chlorostyrene, 3,4-dichlorostyrene, 4-fluorostyrene, and 2,5-difluorostyrene; and nitro-substituted styrenes, such as m-nitrostyrene, o-nitrostyrene, and p-nitrostyrene.

Among these styrene monomers, styrene, p-ethylstyrene, p-n-butylstyrene, and the like may be used in order to enhance the dispersibility of the vinyl resin particles in the toner particles and limit the reduction in fine-line resolution.

The above styrene monomers may be used alone or in combination of two or more.

The (meth)acrylic monomer is a monomer including a (meth)acryloyl group. Specific examples of the (meth)acrylic monomer include alkyl esters of (meth)acrylic acid, such as n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, octyl (meth)acrylate, decyl (meth)acrylate, lauryl (meth)acrylate, stearyl (meth)acrylate, cyclohexyl (meth)acrylate, dicyclopentanyl (meth)acrylate, and isobornyl (meth)acrylate; esters of di(meth)acrylic acid, such as ethylene glycol di(meth)acrylate, diethylene glycol di(meth)acrylate, triethylene glycol di(meth)acrylate, butanediol di(meth)acrylate, pentanediol di(meth)acrylate, hexanediol di(meth)acrylate, nonanediol di(meth)acrylate, and decanediol di(meth)acrylate; carboxy-substituted alkyl esters of (meth)acrylic acid, such as P-carboxyethyl (meth)acrylate; hydroxy-substituted alkyl esters of (meth)acrylic acid, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate; and alkoxy-substituted alkyl esters of (meth)acrylic acid, such as 2-methoxyethyl (meth)acrylate.

Examples of the (meth)acrylic monomer further include, in addition to the above (meth)acrylic acid esters, (meth)acrylic acid.

Among these, (meth)acrylic acid esters including an alkyl group having 2 to 14 (preferably 2 to 10, and more preferably 3 to 8) carbon atoms may be used in order to enhance the dispersibility of the vinyl resin particles in the toner particles and limit the reduction in fine-line resolution.

The above (meth)acrylic monomers may be used alone or in combination of two or more.

Examples of the other monomer include a crosslinking agent used for forming a crosslinked structure.

Examples of the crosslinking agent used for crosslinking include aromatic polyvinyl compounds, such as divinylbenzene and divinylnaphthalene; polyvinyl esters of aromatic polyvalent carboxylic acids, such as divinyl phthalate, divinyl isophthalate, divinyl terephthalate, divinyl homophthalate, trimesic acid divinyl ester, trimesic acid trivinyl ester, divinyl naphthalenedicarboxylate, and divinyl biphenylcarboxylate; divinyl esters of nitrogen-containing aromatic compounds, such as divinyl pyridinedicarboxylate; vinyl esters of unsaturated heterocyclic carboxylic acid compounds, such as vinyl pyromucate, vinyl furancarboxylate, vinyl pyrrole-2-carboxylate, and vinyl thiophenecarboxylate; (meth)acrylic acid esters of linear polyhydric alcohols, such as butanediol methacrylate, hexanediol acrylate, octanediol methacrylate, decanediol acrylate, and dodecanediol methacrylate; (meth)acrylic acid esters of branched or substituted polyhydric alcohols, such as neopentyl glycol dimethacrylate and 2-hydroxy,1,3-diacryloxypropane; and polyvinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetonedicarboxylate, divinyl glutarate, divinyl 3,3′-thiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. The above crosslinking agents may be used alone or in combination of two or more.

In the styrene-(meth)acrylate copolymer particles, the proportion Wa(B) [mol %] of a structural unit derived from the (meth)acrylate in the entire styrene-(meth)acrylate copolymer particles and the proportion Wa(S) [mol %] of a structural unit derived from the (meth)acrylate in the surfaces of the styrene-(meth)acrylate copolymer particles may satisfy the relationship below:

$$2 \leq Wa ( S ) - Wa ( B ) \leq 20$$

$$( preferably , 5 \leq Wa ( S ) - Wa ( B ) \leq 15 ) .$$

In this exemplary embodiment, the proportion Wa(S) [mol %] of a structural unit derived from the (meth)acrylate in the surfaces of the styrene-(meth)acrylate copolymer particles preferably satisfies 40≤Wa(S)≤80 and more preferably satisfies 45≤Wa(S)≤75. When Wa(S) and Wa(B) satisfy the above relationship, a large amount of the structural unit derived from the (meth)acrylate are present in the surfaces of the styrene-(meth)acrylate copolymer particles. Since the surfaces of such styrene-(meth)acrylate copolymer particles have a low glass transition temperature and become soft, the styrene-(meth)acrylate copolymer particles readily absorb external shocks. This reduces the cracking or chipping of the toner particles. Consequently, the reduction in fine-line resolution may be readily limited.

Styrene-(meth)acrylate copolymer particles having the above-described structure may be produced by, for example, adding emulsions including styrene and (meth)acrylate at different ratios one by one in emulsion polymerization.

In the styrene-(meth)acrylate copolymer particles, the proportion Ws(B) [mol %] of a structural unit derived from styrene in the entire styrene-(meth)acrylate copolymer particles and the proportion Ws(S) [mol %] of a structural unit derived from styrene in the surfaces of the styrene-(meth)acrylate copolymer particles may satisfy the relationship below:

$$2 \leq Ws ( S ) - Ws ( B ) \leq 20$$

$$( preferably , 5 \leq Wa ( S ) - Wa ( B ) \leq 15 ) .$$

In this exemplary embodiment, the proportion Ws(S) [mol %] of a structural unit derived from styrene in the surfaces of the styrene-(meth)acrylate copolymer particles preferably satisfies 40≤Ws(S)≤80 and more preferably satisfies 45≤Ws(S)≤75.

When Ws(S) and Ws(B) satisfy the above relationship, a large amount of the structural unit derived from styrene are present in the surfaces of the styrene-(meth)acrylate copolymer particles. In styrene-(meth)acrylate copolymer particles having the above-described structure, the likelihood of a low-molecular-weight component present inside the particles precipitating on the outside of the particles may be reduced. This may limit the degradation of electrification characteristics of the toner which occurs due to the precipitation of the unreacted low-molecular-weight component. As a result, rolling of toner particles which occurs due to a reduction in the electrostatic adhesive force of the toner particles may be reduced. Consequently, the reduction in fine-line resolution may be readily limited.

Styrene-(meth)acrylate copolymer particles having the above-described structure may be produced by, for example, adding emulsions including styrene and (meth)acrylate at different ratios one by one in emulsion polymerization.

The proportions of the above structural units in the entirety and surfaces of the styrene-(meth)acrylate copolymer particles may be determined in the following manner. The proportions of the above structural units in the entirety of the styrene-(meth)acrylate copolymer particles are determined by preparing a pellet-like sample by a KBr method and analyzing the sample by infrared absorption spectroscopy. Using an absorption at 1730 cm⁻¹, which is derived from the carbonyl stretching vibrations of the (meth) acryl structure, and an absorption at 698 cm⁻¹, which is derived from the CH out-of-plane bending vibrations of the styrene structure, a resin composed only of styrene and a resin composed only of (meth)acrylate are prepared, and a calibration curve with which a content can be calculated on the basis of the amount of absorption is prepared. The proportions of the structural units are calculated on the basis of the amounts of absorptions of the styrene-(meth)acrylate copolymer.

In the calculation of the proportions of the structural units in the surfaces of the styrene-(meth)acrylate copolymer particles, the composition of the surfaces of the resin particles is analyzed with X-ray photoelectron spectroscopy (XPS). The ratio O(p) of the amount of oxygen atoms to the total amount of the carbon and oxygen atoms included in the styrene-(meth)acrylate copolymer particles is calculated using the formula below.

O(p)=Number of oxygen atoms/(Number of carbon atoms+Number of oxygen atoms)

A resin composed only of (meth)acrylate is prepared, and the proportion O(a) of oxygen atoms in the (meth)acrylate is determined in the same manner as described above.

On the basis of the above measurement results, with the sum of styrene and (meth)acrylate being defined as 1, the proportion Wa(S) of (meth)acrylate present on the surfaces and the proportion Ws(S) of styrene present on the surfaces may be calculated using the formulae below.

$$Wa ( S ) = O ( p ) / O ( a )$$

$$Ws ( S ) = 1 - ( O ( p ) / O ( a ) )$$

The vinyl resin particles may have a crosslinked structure.

When the vinyl resin particles have a crosslinked structure, the resin particles are likely to have elasticity and, accordingly, the toner particles are likely to have elasticity. This makes it easy to reduce the cracking or chipping of the toner particles. Consequently, the reduction in fine-line resolution may be readily limited.

The expression “vinyl resin particles have a crosslinked structure” used herein means that a crosslinked structure is present between specific atoms constituting the high-molecular-weight structure included in the resin particles.

Examples of the crosslinked structure included in the vinyl resin particles include a crosslinked structure formed by ionic bonds and a crosslinked structure formed by covalent bonds. Among these, a crosslinked structure formed by covalent bonds may be included in the vinyl resin particles.

The volume average size of the vinyl resin particles is preferably 100 nm or more and 300 nm or less, is more preferably 120 nm or more and 250 or less, and is further preferably 140 nm or more and 220 or less.

When the volume average size of the vinyl resin particles falls within the above range, the vinyl resin particles have an adequate size, and the cracking or chipping of the toner particles may be reduced. Furthermore, the mismatch between the “center of mass” and “geometric center” of each of the toner particles is not likely to occur, and the occurrence of off-center may be reduced. Consequently, the reduction in fine-line resolution may be readily limited.

The volume average size of the vinyl resin particles may be determined in the following manner.

The vinyl resin particles are separated from the toner using the difference in solubility in organic solvents between the vinyl resin particles and organic substances other than the vinyl resin particles. For separating the vinyl resin particles from the toner, for example, the toner is immersed in a solvent in which the binder resin is soluble and the resin particles are insoluble in order to dissolve the binder resin in the solvent.

In the case where the toner includes inorganic substances, such as an external additive and a colorant, the vinyl resin particles may be taken by separating them from the inorganic substances by centrifugation.

The particle diameter distribution of the vinyl resin particles is obtained using a laser-diffraction particle-size-distribution measurement apparatus, such as “LS-13 320” produced by Beckman Coulter, Inc. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v.

The glass transition temperature Tg of the vinyl resin particles is preferably 0° C. or more and 30° C. or less and is more preferably 5° C. or more and 25° C. or less. When the glass transition temperature Tg of the vinyl resin particles falls within the above range, the toner particles may have adequate flexibility and both deformation and cracking or chipping of the toner particles may be reduced. Moreover, the mismatch between the “center of mass” and “geometric center” of each of the toner particles is not likely to occur, and the occurrence of off-center may be reduced. Consequently, the reduction in fine-line resolution may be readily limited.

The glass transition temperature Tg of the vinyl resin particles is determined in the following manner.

The vinyl resin particles are separated from the toner using the difference in solubility in organic solvents between the vinyl resin particles and organic substances other than the vinyl resin particles. For separating the vinyl resin particles from the toner, for example, the toner is immersed in a solvent in which the binder resin is soluble and the resin particles are insoluble in order to dissolve the binder resin in the solvent.

In the case where the toner includes inorganic substances, such as an external additive and a colorant, the vinyl resin particles may be taken by separating them from the inorganic substances by centrifugation.

A pressure is applied to the vinyl resin particles to prepare a disc-like sample having a thickness of 2 mm and a diameter of 8 mm. This sample is used for the measurement. The disc-like sample for the measurement is sandwiched between parallel plates having a diameter of 8 mm. While the amount of strain is set to 0.1% to 100% and the measurement temperature is increased from 10° C. to 150° C. at 2° C./min, dynamic viscoelasticity is measured under the following conditions. Using the storage modulus curve and the loss modulus curve obtained in the measurement, the storage elastic modulus G′ and the loss tangent tan 6 are determined. The peak temperature of the loss tangent tan 6 is considered the glass transition temperature Tg.

The solubility parameter SP(sa) of the surfaces of the vinyl resin particles and the solubility parameter SP(ap) of the binder resin preferably satisfy |SP(ap)−SP(sa)|≤1.0 and more preferably satisfy |SP(ap)−SP(sa)|≤0.6.

When the solubility parameter SP(sa) of the surfaces of the vinyl resin particles and the solubility parameter SP(ap) of the binder resin satisfy the above relationship, the dispersibility of the vinyl resin particles is enhanced, the mismatch between the “center of mass” and “geometric center” of each of the toner particles is not likely to occur, and the occurrence of off-center may be reduced. Consequently, the reduction in fine-line resolution may be readily limited.

The solubility parameter (SP value) is a value defined by the following formula as a function of cohesive energy density.

$$δ = {( Δ E / V )}^{1 / 2}$$

where,
ΔE: intermolecular cohesive energy (evaporation heat)
V: Total volume of liquid mixture
ΔE/V: Cohesive energy density

In the case where the proportions of the monomers constituting the resin are known, the solubility parameter may be calculated using the Fedor's method described below (the method described in Polym. Eng. Sci., 14[2], 1974).

$$Solubility parameter value = {( \sum Δ ei / \sum Δ vi )}^{1 / 2}$$

where,
Δei: evaporation energy of an atom or atomic group
Δvi: molar volume of an atom or atomic group

Note that the solubility parameters (SP values) described in the present disclosure are primarily values calculated on the basis of the monomer proportions.

The solubility parameter SP(sa) of the surfaces of the vinyl resin particles is determined by calculating the proportions of the structural units in the surfaces of the vinyl resin particles as in the measurement of the proportions of the structural units in the surfaces of the styrene-(meth)acrylate copolymer particles described above.

The content of the vinyl resin particles is preferably 5% by mass or more and 15% by mass or less, is more preferably 7% by mass or more and 13% by mass or less, and is further preferably 8% by mass or more and 12% by mass or less of the total amount of the entire toner particles.

When the ratio of the content of the resin particles to the total amount of the toner particles falls within the above range, the toner is likely to have adequate elasticity and the cracking or chipping of the toner particles may be reduced accordingly. Consequently, the reduction in fine-line resolution may be readily limited.

### Colorant

Examples of the colorant include pigments, such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watching Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and dyes, such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

The above colorants may be used alone or in combination of two or more.

The colorant may optionally be subjected to a surface treatment and may be used in combination with a dispersant. Plural types of colorants may be used in combination.

For example, the content of the colorant in the entire toner particles is preferably 1% by mass or more and 30% by mass or less and is more preferably 3% by mass or more and 15% by mass or less.

### Release Agent

Examples of the release agent include, but are not limited to, hydrocarbon waxes; natural waxes, such as a carnauba wax, a rice bran wax, and a candelilla wax; synthetic or mineral-petroleum-derived waxes, such as a montan wax; and ester waxes, such as a fatty-acid ester wax and a montanate wax.

The melting temperature of the release agent is preferably 50° C. or more and 110° C. or less and is more preferably 60° C. or more and 100° C. or less.

The above melting temperature is determined from the “melting peak temperature” according to a method for determining melting temperature which is described in JIS K 7121:1987 “Testing Methods for Transition Temperatures of Plastics” using a DSC curve obtained by differential scanning calorimetry (DSC).

For example, the content of the release agent in the entire toner particles is preferably 1% by mass or more and 20% by mass or less and is more preferably 5% by mass or more and 15% by mass or less.

### Other Additives

Examples of the other additives include additives known in the related art, such as a magnetic substance, a charge-controlling agent, and an inorganic powder. These additives may be added to the toner particles as internal additives.

### Properties, Etc. of Toner Particles

The toner particles may have a single-layer structure or a “core-shell” structure constituted by a core (i.e., core particle) and a coating layer (i.e., shell layer) covering the core.

The volume average diameter D50v of the toner particles is preferably 2 μm or more and 10 μm or less and is more preferably 4 μm or more and 8 μm or less.

The various average particle sizes and various particle size distribution indices of the toner particles are measured using “COULTER MULTISIZER II” produced by Beckman Coulter, Inc. with an electrolyte “ISOTON-II” produced by Beckman Coulter, Inc. in the following manner.

A sample to be measured (0.5 mg or more and 50 mg or less) is added to 2 ml of a 5%-aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 μm or more and 60 μm or less is measured using COULTER MULTISIZER II with an aperture having a diameter of 100 μm. The number of the particles sampled is 50,000.

The particle diameter distribution measured is divided into a number of particle diameter ranges (i.e., channels). For each range, in ascending order in terms of particle diameter, the cumulative volume and the cumulative number are calculated and plotted to draw cumulative distribution curves. Particle diameters at which the cumulative volume and the cumulative number reach 16% are considered to be the volume particle diameter D16v and the number particle diameter D16p, respectively. Particle diameters at which the cumulative volume and the cumulative number reach 50% are considered to be the volume average particle diameter D50v and the number average particle diameter D50p, respectively. Particle diameters at which the cumulative volume and the cumulative number reach 84% are considered to be the volume particle diameter D84v and the number particle diameter D84p, respectively.

Using the volume particle diameters and number particle diameters measured, the volume particle size distribution index (GSDv) is calculated as (D84v/D16v)^{1/2} and the number particle size distribution index (GSDp) is calculated as (D84p/D16p)^{1/2}.

The toner particles preferably has an average circularity of 0.94 or more and 1.00 or less. The average circularity of the toner particles is more preferably 0.95 or more and 0.98 or less.

The average circularity of the toner particles is determined as [Equivalent circle perimeter]/[Perimeter] (i.e., [Perimeter of a circle having the same projection area as the particles]/[Perimeter of the projection image of the particles]. Specifically, the average circularity of the toner particles is determined by the following method.

The toner particles to be measured are sampled by suction so as to form a flat stream. A static image of the particles is taken by instantaneously flashing a strobe light. The image of the particles is analyzed with a flow particle image analyzer “FPIA-3000” produced by Sysmex Corporation. The number of samples used for determining the average circularity of the toner particles is 3,500.

In the case where the toner includes an external additive, the toner (i.e., the developer) to be measured is dispersed in water containing a surfactant and then subjected to an ultrasonic wave treatment in order to remove the external additive from the toner particles.

### External Additive

Examples of the external additive include inorganic particles. Examples of the inorganic particles include SiO₂ particles, TiO₂ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaO·SiO₂ particles, K₂O·(TiO₂)ₙ particles, Al₂O₃·2SiO₂ particles, CaCO₃ particles, MgCO₃ particles, BaSO₄ particles, and MgSO₄ particles.

The surfaces of the inorganic particles used as an external additive may be subjected to a hydrophobic treatment. The hydrophobic treatment is performed by, for example, immersing the inorganic particles in a hydrophobizing agent. Examples of the hydrophobizing agent include, but are not limited to, a silane coupling agent, a silicone oil, a titanate coupling agent, and aluminum coupling agent. These hydrophobizing agents may be used alone or in combination of two or more.

The amount of the hydrophobizing agent is commonly, for example, 1 part by mass or more and 10 parts by mass or less relative to 100 parts by mass of the inorganic particles.

Examples of the external additive further include particles of a resin, such as polystyrene, polymethyl methacrylate (PMMA), or a melamine resin; and particles of a cleaning lubricant, such as a metal salt of a higher fatty acid, such as zinc stearate, or a fluorine-contained resin.

The amount of the external additive used is, for example, preferably 0.01% by mass or more and 5% by mass or less and is more preferably 0.01% by mass or more and 2.0% by mass or less of the amount of the toner particles.

### Method for Producing Toner

A method for producing the toner according to this exemplary embodiment is described below.

The toner according to the exemplary embodiment is produced by, after the preparation of the toner particles, depositing an external additive on the surfaces of the toner particles.

Aggregation coalescence may be used in order to prepare the toner particles.

Specifically, for example, the toner particles are produced by the following steps:
preparing a binder resin particle dispersion liquid in which particles of a resin that serves as a binder resin are dispersed and a vinyl resin particle dispersion liquid in which the vinyl resin particles are dispersed (dispersion liquid preparation step);
causing the binder resin particles and the vinyl resin particles (and other particles as needed) to aggregate with one another in the dispersion liquid (or a dispersion liquid that further includes the other particle dispersion liquid as needed) to form aggregated particles (aggregated particle formation step); and
heating the resulting aggregated particle dispersion liquid in which the aggregated particles are dispersed to cause fusion and coalescence of the aggregated particles and form toner particles (fusion and coalescence step).

The toner particles that satisfy Formulae (1) and (2) are produced by, for example, the following method.

In the dispersion liquid preparation step, a mixed dispersion liquid is prepared by mixing the vinyl resin particle dispersion liquid with a dispersion liquid in which particles other than the vinyl resin particles (e.g., binder resin particles, colorant particle, and release agent particles) are dispersed. The pH of the mixed dispersion liquid is adjusted to 2 or more and 5 or less. While the mixed dispersion liquid is slowly stirred with the velocity of the front end of the stirring impeller being set to, for example, 0.28 m/sec or more and 0.57 m/sec or less (e.g., when the diameter of the stirring impeller is 20 cm, at a rotational speed of 26.7 rpm or more and 54.4 rpm or less), the vinyl resin particle dispersion liquid is added dropwise to the mixed dispersion liquid in order to form aggregated particles. This enables the vinyl resin particles to aggregate with the other particles with high dispersibility. Consequently, the dispersibility of the vinyl resin particles in the toner particles may be enhanced, and the toner particles that satisfy Formulae (1) and (2) may be produced.

Alternatively, when the vinyl resin particle dispersion liquid is added dropwise to the mixed dispersion liquid to form aggregated particles, a coagulant may be added to the mixed dispersion liquid.

Each of the above steps is described below in detail.

Hereinafter, a method for preparing toner particles including a colorant and a release agent is described. However, it should be noted that the colorant is optional. It is needless to say that additives other than a colorant may be used.

### Dispersion Liquid Preparation Step

First, a binder resin particle dispersion liquid in which particles of a resin that serves as a binder resin are dispersed is prepared. Furthermore, a colorant particle dispersion liquid in which particles of a colorant are dispersed and a release agent particle dispersion liquid in which particles of a release agent are dispersed are prepared.

The binder resin particle dispersion liquid is prepared by, for example, dispersing the binder resin particles in a dispersion medium using a surfactant.

Examples of the dispersion medium used for preparing the binder resin particle dispersion liquid include aqueous media.

Examples of the aqueous media include water, such as distilled water and ion-exchange water; and alcohols. These aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the binder resin particle dispersion liquid, the binder resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the binder resin particles used, the binder resin particles may be dispersed in the binder resin particle dispersion liquid by, for example, phase-inversion emulsification.

Phase-inversion emulsification is a method in which the resin to be dispersed is dissolved in a hydrophobic organic solvent in which the resin is soluble, a base is added to the resulting organic continuous phase (i.e., O phase) to perform neutralization, and subsequently an aqueous medium (i.e., W phase) is charged in order to perform conversion of resin (i.e., phase inversion) from W/O to O/W, form a discontinuous phase, and disperse the resin in the aqueous medium in the form of particles.

The volume average diameter of the binder resin particles dispersed in the binder resin particle dispersion liquid is preferably, for example, 0.01 μm or more and 1 μm or less, is more preferably 0.08 μm or more and 0.8 μm or less, and is further preferably 0.1 μm or more and 0.6 μm or less.

The volume average diameter of the binder resin particles is determined in the following manner. The particle diameter distribution of the resin particles is obtained using a laser-diffraction particle-size-distribution measurement apparatus, such as “LS-13 320” produced by Beckman Coulter Inc. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume average diameters of particles included in the other dispersion liquids are also determined in the above-described manner.

The content of the binder resin particles included in the binder resin particle dispersion liquid is, for example, preferably 5% by mass or more and 50% by mass or less and is more preferably 10% by mass or more and 40% by mass or less.

The colorant particle dispersion liquid, the release agent particle dispersion liquid, and the like are also prepared as in the preparation of the binder resin particle dispersion liquid. In other words, the above-described specifications for the volume average diameter of the particles included in the binder resin particle dispersion liquid, the dispersion medium of the binder resin particle dispersion liquid, the dispersion method used for preparing the binder resin particle dispersion liquid, and the content of the particles in the binder resin particle dispersion liquid can also be applied to colorant particles dispersed in the colorant particle dispersion liquid and release agent particles dispersed in the release agent particle dispersion liquid.

### Preparation of Vinyl Resin Particle Dispersion Liquid

Publicly known methods, such as emulsion polymerization, a melt-kneading method in which a Banbury mixer, a kneader, or the like is used, suspension polymerization, and spray drying, may be used for preparing the vinyl resin particle dispersion liquid. Among these, emulsion polymerization may be used.

A styrene monomer and a (meth)acrylate monomer may be used as monomers and polymerized with each other in the presence of a crosslinking agent in order to adjust the loss factor to fall within the preferable range. In the production of the vinyl resin particles, emulsion polymerization may be performed in a plurality of stages.

The method for producing the vinyl resin particles is specifically described below.

The method for preparing the vinyl resin particle dispersion liquid may include the following steps:
preparing an emulsion including monomers, a crosslinking agent, a surfactant, and water (emulsion preparation step);
adding a polymerization initiator to the emulsion and heating the resulting mixture to cause polymerization of the monomers (first emulsion polymerization step); and
adding an emulsion including monomers to the reaction solution produced by the first emulsion polymerization step and heating the resulting mixture to cause polymerization of the monomers (second emulsion polymerization step).

In the case where a styrene monomer and a (meth)acrylate monomer are used as monomers, the proportion of the styrene monomer in the monomers included in the reaction solution in the first emulsion polymerization step and the proportion of the styrene monomer in the monomers added in the second emulsion polymerization step may be adjusted with consideration of the difference in reactivity in order to change the state of molecular chain or state of crosslinking of the resin.

In addition to the adjustment of the proportions of the monomers, for example, the polymerization temperature, the amount of polymerization initiator added, the method of adding the polymerization initiator, the speed at which the emulsion is added dropwise, and the amount of crosslinking agent added may be changed with consideration of the reactivities of the monomers in order to change the state of molecular chain or state of crosslinking of the resin.

### Emulsion Preparation Step

The emulsion preparation step is a step of preparing an emulsion including monomers, a crosslinking agent, a surfactant, and water.

The emulsion may be prepared by emulsifying monomers, a crosslinking agent, a surfactant, and water with an emulsifier.

Examples of the emulsifier include a rotary stirrer equipped with a propeller-type, anchor-type, paddle-type, or turbine-type impeller; a static mixing machine, such as a static mixer; a homogenizer; a rotor-stator emulsifier, such as CLEARMIX; a mill emulsifier having a grinding function; a high-pressure emulsifier, such as a Manton-Gaulin pressure emulsifier; a high-pressure nozzle emulsifier that generates cavitation at high pressures; a high-pressure collision emulsifier that generates a shear force by causing liquid particles to collide with one another at high pressures, such as Microfluidizer; an ultrasonic emulsifier that generates cavitation using ultrasonic waves; and a membrane emulsifier that performs homogeneous emulsification through pores.

A styrene monomer and a (meth)acrylate monomer may be used as monomers.

The crosslinking agent may be the above-described crosslinking agent.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. The nonionic surfactants may be used in combination with the anionic surfactants and the cationic surfactants. Among these surfactants, the anionic surfactants may be used. These surfactants may be used alone or in combination of two or more.

The emulsion may include a chain transfer agent. The chain transfer agent may be, but not limited to, a compound having a thiol component. Specific examples thereof include alkyl mercaptans, such as hexyl mercaptan, heptyl mercaptan, octyl mercaptan, nonyl mercaptan, decyl mercaptan, and dodecyl mercaptan.

### First Emulsion Polymerization Step

The first emulsion polymerization step is a step of adding a polymerization initiator to the emulsion and heating the resulting mixture to cause polymerization of the monomers.

When polymerization is performed, the emulsion (reaction solution) including the polymerization initiator may be stirred with a stirrer.

Examples of the stirrer include a rotary stirrer equipped with a propeller-type, anchor-type, paddle-type, or turbine-type impeller.

Ammonium persulfate may be used as a polymerization initiator.

### Second Emulsion Polymerization Step

The second emulsion polymerization step is a step of adding an emulsion including monomers to the reaction solution produced in the first emulsion polymerization step and heating the resulting mixture to cause polymerization of the monomers.

When polymerization is performed, the reaction solution may be stirred as in the first emulsion polymerization step.

In this step, the emulsion may be added to the reaction solution in a plurality of stages in small amounts while the ratio between the styrene monomer and the (meth)acrylate monomer included in the emulsion is changed.

The emulsion including monomers may be produced by, for example, emulsifying the monomer, a surfactant, and water with an emulsifier.

The vinyl resin particle dispersion liquid may be prepared by the above-described step.

### Aggregated Particle Formation Step

The binder resin particle dispersion liquid is mixed with the colorant particle dispersion liquid and the release agent particle dispersion liquid. The pH of the resulting mixed dispersion liquid is adjusted to 2 or more and 5 or less, and the pH of the vinyl resin particle dispersion liquid is adjusted to fall within a range of the pH of the mixed dispersion liquid plus or minus 0.5.

While the mixed dispersion liquid is slowly stirred with the speed of the front end of a stirring impeller being set to, for example, 0.28 m/sec or more and 0.57 m/sec or less (e.g., when the diameter of the stirring impeller is 20 cm, at a rotational speed of 26.7 rpm or more and 54.4 rpm or less), the vinyl resin particle dispersion is added to the mixed dispersion liquid in order to perform heteroaggregation of the binder resin particles, the colorant particles, the release agent particles, and the vinyl resin particles. Hereby, aggregated particles that include the binder resin particles, the colorant particles, the release agent particles, and the vinyl resin particles and that have a diameter close to that of the intended toner particles are formed.

Specifically, for example, a coagulant is added to the mixed dispersion liquid, and the pH of the mixed dispersion liquid is controlled to be acidic (e.g., pH of 2 or more and 5 or less). A dispersion stabilizer may be added to the mixed dispersion liquid as needed. Subsequently, the mixed dispersion liquid is heated to the glass transition temperature of the resin particles (specifically, e.g., [Glass transition temperature of the binder resin particles −30° C.] or more and [the Glass transition temperature −10° C.] or less), and thereby the particles dispersed in the mixed dispersion liquid are caused to aggregate together to form aggregated particles.

In the aggregated particle formation step, alternatively, for example, the above coagulant may be added to the mixed dispersion liquid at room temperature (e.g., 25° C.) while the mixed dispersion liquid to which the vinyl resin particle dispersion liquid has been added dropwise is stirred using a rotary-shearing homogenizer. Then, the pH of the mixed dispersion liquid is controlled to be acidic (e.g., pH of 2 or more and 5 or less), and a dispersion stabilizer may be added to the mixed dispersion liquid as needed. Subsequently, the mixed dispersion liquid is heated in the above-described manner.

Examples of the coagulant include surfactants, inorganic metal salts, and divalent or higher metal complexes that have a polarity opposite to that of the surfactant included in the mixed dispersion liquid as a dispersant. In particular, using a metal complex as a coagulant reduces the amount of surfactant used and, as a result, charging characteristics may be enhanced.

An additive capable of forming a complex or a bond similar to a complex with the metal ions contained in the coagulant may optionally be used. An example of the additive is a chelating agent.

Examples of the inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The chelating agent may be a water-soluble chelating agent. Examples of such a chelating agent include oxycarboxylic acids, such as tartaric acid, citric acid, and gluconic acid; and iminodiacetic acid (IDA), nitrilotriacetic acid (NTA), and ethylenediaminetetraacetic acid (EDTA).

The amount of the chelating agent used is, for example, preferably 0.01 parts by mass or more and 5.0 parts by mass or less and is more preferably 0.1 parts by mass or more and less than 3.0 parts by mass relative to 100 parts by mass of the resin particles.

### Fusion Coalescence Step

The aggregated particle dispersion liquid in which the aggregated particles are dispersed is heated to, for example, a temperature equal to or higher than the glass transition temperature of the binder resin particles (e.g., [Glass transition temperature of the binder resin particles+10° C.] or more and [the Glass transition temperature+30° C.] or less) in order to perform fusion and coalescence of the aggregated particles and form toner particles.

The toner particles are produced through the above-described steps. The toner particles may be produced by, subsequent to the preparation of the aggregated particle dispersion liquid in which the aggregated particles are dispersed, mixing the aggregated particle dispersion liquid with the binder resin particle dispersion liquid and causing aggregation such that the binder resin particles are adhered onto the surfaces of the aggregated particles to form second aggregated particles; and heating a second aggregated particle dispersion liquid in which the second aggregated particles are dispersed to cause fusion and coalescence of the second aggregated particles and form toner particles having a core-shell structure.

After the completion of the fusion-coalescence step, the toner particles formed in the solution are subjected to any suitable cleaning step, solid-liquid separation step, and drying step that are known in the related art in order to obtain dried toner particles.

In the cleaning step, the toner particles may be subjected to displacement washing using ion-exchange water to a sufficient degree from the viewpoint of electrification characteristics. Examples of a solid-liquid separation method used in the solid-liquid separation step include, but are not limited to, suction filtration and pressure filtration from the viewpoint of productivity. Examples of a drying method used in the drying step include, but are not limited to, freeze-drying, flash drying, fluidized drying, and vibrating fluidized drying from the viewpoint of productivity.

The toner according to the exemplary embodiment is produced by, for example, adding an external additive to the dried toner particles and mixing the resulting toner particles using a V-blender, a HENSCHEL mixer, a Lodige mixer, or the like. Optionally, coarse toner particles may be removed using a vibrating screen classifier, a wind screen classifier, or the like.

### Electrostatic Image Developer

An electrostatic image developer according to the exemplary embodiment includes at least the toner according to the exemplary embodiment.

The electrostatic image developer according to the exemplary embodiment may be a single component developer including only the toner according to the exemplary embodiment or may be a two-component developer that is a mixture of the toner and a carrier.

The type of the carrier is not limited, and any suitable carrier known in the related art may be used. Examples of the carrier include a coated carrier prepared by coating the surfaces of cores including magnetic powder particles with a resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating the surfaces of particles constituting the carrier, that is, core particles, with a resin.

Examples of the magnetic powder include powders of magnetic metals, such as iron, nickel, and cobalt; and powders of magnetic oxides, such as ferrite and magnetite.

Examples of the coat resin and the matrix resin include polyethylene, polypropylene, polystyrene, poly(vinyl acetate), poly(vinyl alcohol), poly(vinyl butyral), poly(vinyl chloride), poly(vinyl ether), poly(vinyl ketone), a vinyl chloride-vinyl acetate copolymer, a styrene-acrylic acid ester copolymer, a straight silicone resin including an organosiloxane bond and the modified products thereof, a fluorine resin, polyester, polycarbonate, a phenolic resin, and an epoxy resin.

The coat resin and the matrix resin may optionally include additives, such as conductive particles.

Examples of the conductive particles include particles of metals, such as gold, silver, and copper; and particles of carbon black, titanium oxide, zinc oxide, tin oxide, barium sulfate, aluminum borate, and potassium titanate.

The surfaces of the cores can be coated with a resin by, for example, using a coating-layer forming solution prepared by dissolving the coat resin and, as needed, various types of additives in a suitable solvent. The type of the solvent is not limited and may be selected with consideration of the type of the resin used, ease of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the toner to the carrier in the two-component developer is preferably toner:carrier=1:100 to 30:100 and is more preferably 3:100 to 20:100.

### Image Forming Apparatus and Image Forming Method

An image forming apparatus and an image forming method according to the exemplary embodiment are described below.

The image forming apparatus according to the exemplary embodiment includes an image holding member; a charging unit that charges the surface of the image holding member; an electrostatic image formation unit that forms an electrostatic image on the charged surface of the image holding member; a developing unit that includes an electrostatic image developer and develops the electrostatic image formed on the surface of the image holding member with the electrostatic image developer to form a toner image; a transfer unit that transfers the toner image formed on the surface of the image holding member onto the surface of a recording medium; and a fixing unit that fixes the toner image onto the surface of the recording medium. The electrostatic image developer is the electrostatic image developer according to the exemplary embodiment.

The image forming apparatus according to the exemplary embodiment uses an image forming method (image forming method according to the exemplary embodiment) including charging the surface of the image holding member; forming an electrostatic image on the charged surface of the image holding member; developing the electrostatic image formed on the surface of the image holding member with the electrostatic image developer according to the exemplary embodiment to form a toner image; transferring the toner image formed on the surface of the image holding member onto the surface of a recording medium; and fixing the toner image onto the surface of the recording medium.

The image forming apparatus according to the exemplary embodiment may be any image forming apparatus known in the related art, such as a direct-transfer image forming apparatus in which a toner image formed on the surface of an image holding member is directly transferred to a recording medium; an intermediate-transfer image forming apparatus in which a toner image formed on the surface of an image holding member is transferred onto the surface of an intermediate transfer body in the first transfer step and the toner image transferred on the surface of the intermediate transfer body is transferred onto the surface of a recording medium in the second transfer step; an image forming apparatus including a cleaning unit that cleans the surface of the image holding member subsequent to the transfer of the toner image before the image holding member is again charged; and an image forming apparatus including a static-erasing unit that erases static by irradiating the surface of an image holding member with static-erasing light subsequent to the transfer of the toner image before the image holding member is again charged.

In the case where the image forming apparatus according to this exemplary embodiment is the intermediate-transfer image forming apparatus, the transfer unit may be constituted by, for example, an intermediate transfer body to which a toner image is transferred, a first transfer subunit that transfers a toner image formed on the surface of the image holding member onto the surface of the intermediate transfer body in the first transfer step, and a second transfer subunit that transfers the toner image transferred on the surface of the intermediate transfer body onto the surface of a recording medium in the second transfer step.

In the image forming apparatus according to the exemplary embodiment, for example, a portion including the developing unit may have a cartridge structure (i.e., process cartridge) detachably attachable to the image forming apparatus. An example of the process cartridge is a process cartridge including the electrostatic image developer according to the exemplary embodiment and the developing unit.

An example of the image forming apparatus according to the exemplary embodiment is described below, but the image forming apparatus is not limited thereto. Hereinafter, only components illustrated in drawings are described; others are omitted.

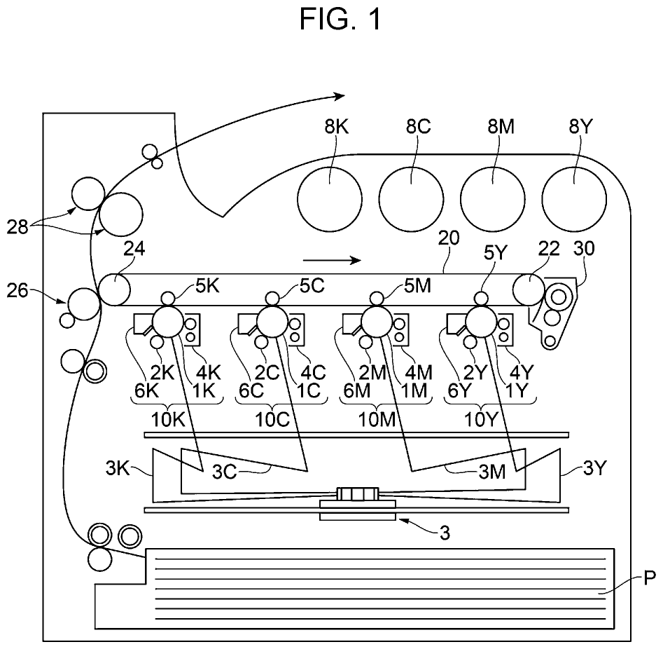

FIG. 1 schematically illustrates the image forming apparatus according to the exemplary embodiment.

The image forming apparatus illustrated in FIG. 1 includes first to fourth electrophotographic image formation units 10Y, 10M, 10C, and 10K that form yellow (Y), magenta (M), cyan (C), and black (K) images, respectively, on the basis of color separation image data. The image formation units (hereinafter, referred to simply as “units”) 10Y, 10M, 10C, and 10K are horizontally arranged in parallel at a predetermined distance from one another. The units 10Y, 10M, 10C, and 10K may be process cartridges detachably attachable to the image forming apparatus.

An intermediate transfer belt 20 that serves as an intermediate transfer body runs above (in FIG. 1) and extends over the units 10Y, 10M, 10C, and 10K. The intermediate transfer belt 20 is wound around a drive roller 22 and a support roller 24 arranged to contact with the inner surface of the intermediate transfer belt 20, which are spaced from each other in a direction from left to right in FIG. 1, and runs clockwise in FIG. 1, that is, in the direction from the first unit 10Y to the fourth unit 10K. Using a spring or the like (not illustrated), a force is applied to the support roller 24 in a direction away from the drive roller 22, thereby applying tension to the intermediate transfer belt 20 wound around the drive roller 22 and the support roller 24. An intermediate transfer body-cleaning device 30 is disposed so as to contact with the image-carrier-side surface of the intermediate transfer belt 20 and to face the drive roller 22.

Developing devices (i.e., developing units) 4Y, 4M, 4C, and 4K of the units 10Y, 10M, 10C, and 10K are supplied with yellow, magenta, cyan, and black toners stored in toner cartridges 8Y, 8M, 8C, and 8K, respectively.

Since the first to fourth units 10Y, 10M, 10C, and 10K have the same structure and the same action, the following description is made with reference to, as a representative, the first unit 10Y that forms an yellow image and is located upstream in a direction in which the intermediate transfer belt runs. Note that components of the second to fourth units 10M, 10C, and 10K which are equivalent to the above-described components of the first unit 10Y are denoted with reference numerals including magenta (M), cyan (C), or black (K) instead of yellow (Y), and the descriptions of the second to fourth units 10M, 10C, and 10K are omitted.

The first unit 10Y includes a photosensitive member 1Y serving as an image holding member. The following components are disposed around the photosensitive member 1Y sequentially in the counterclockwise direction: a charging roller (example of the charging unit) 2Y that charges the surface of the photosensitive member 1Y at a predetermined potential; an exposure device (example of the electrostatic image formation unit) 3 that forms an electrostatic image by irradiating the charged surface of the photosensitive member 1Y with a laser beam 3Y based on a color separated image signal; a developing device (example of the developing unit) 4Y that develops the electrostatic image by supplying a charged toner to the electrostatic image; a first transfer roller (example of the first transfer subunit) 5Y that transfers the developed toner image to the intermediate transfer belt 20; and a photosensitive-member cleaning device (example of the cleaning unit) 6Y that removes a toner remaining on the surface of the photosensitive member 1Y after the first transfer.

The first transfer roller 5Y is disposed so as to contact with the inner surface of the intermediate transfer belt 20 and to face the photosensitive member 1Y. Each of the first transfer rollers 5Y, 5M, 5C, and 5K is connected to a bias power supply (not illustrated) that applies a first transfer bias to the first transfer rollers. Each bias power supply varies the transfer bias applied to the corresponding first transfer roller on the basis of the control by a controller (not illustrated).

The action of forming a yellow image in the first unit 10Y is described below.

Before the action starts, the surface of the photosensitive member 1Y is charged at a potential of −600 to −800 V by the charging roller 2Y.

The photosensitive member 1Y is formed by stacking a photosensitive layer on a conductive substrate (e.g., volume resistivity at 20° C.: 1×10⁻⁶ Ωcm or less). The photosensitive layer is normally of high resistance (comparable with the resistance of ordinary resins), but, upon being irradiated with the laser beam 3Y, the specific resistance of the portion irradiated with the laser beam varies. Thus, the exposure device 3 irradiates the surface of the charged photosensitive member 1Y with the laser beam 3Y on the basis of the image data of the yellow image sent from the controller (not illustrated). The laser beam 3Y is impinged on the photosensitive layer formed in the surface of the photosensitive member 1Y. As a result, an electrostatic image of yellow image pattern is formed on the surface of the photosensitive member 1Y.

The term “electrostatic image” used herein refers to an image formed on the surface of the photosensitive member 1Y by charging, the image being a “negative latent image” formed by irradiating a portion of the photosensitive layer with the laser beam 3Y to reduce the specific resistance of the irradiated portion such that the charges on the irradiated surface of the photosensitive member 1Y discharge while the charges on the portion that is not irradiated with the laser beam 3Y remain.

The electrostatic image, which is formed on the photosensitive member 1Y as described above, is sent to the predetermined developing position by the rotating photosensitive member 1Y. The electrostatic image on the photosensitive member 1Y is visualized (i.e., developed) in the form of a toner image by the developing device 4Y at the developing position.

The developing device 4Y includes an electrostatic image developer including, for example, at least, a yellow toner and a carrier. The yellow toner is stirred in the developing device 4Y to be charged by friction and supported on a developer roller (example of the developer support), carrying an electric charge of the same polarity (i.e., negative) as the electric charge generated on the photosensitive member 1Y. The yellow toner is electrostatically adhered to the erased latent image portion on the surface of the photosensitive member 1Y as the surface of the photosensitive member 1Y passes through the developing device 4Y. Thus, the latent image is developed using the yellow toner. The photosensitive member 1Y on which the yellow toner image is formed keeps rotating at the predetermined rate, thereby transporting the toner image developed on the photosensitive member 1Y to the predetermined first transfer position.

Upon the yellow toner image on the photosensitive member 1Y reaching the first transfer position, first transfer bias is applied to the first transfer roller 5Y so as to generate an electrostatic force on the toner image in the direction from the photosensitive member 1Y toward the first transfer roller 5Y. Thus, the toner image on the photosensitive member 1Y is transferred to the intermediate transfer belt 20. The transfer bias applied has the opposite polarity (+) to that of the toner (−) and controlled to be, for example, in the first unit 10Y, +10 μA by a controller (not illustrated).

The toner particles remaining on the photosensitive member 1Y are removed by the photosensitive-member cleaning device 6Y and then collected.

Each of the first transfer biases applied to first transfer rollers 5M, 5C, and 5K of the second, third, and fourth units 10M, 10C, and 10K is controlled in accordance with the first unit 10Y.

Thus, the intermediate transfer belt 20, on which the yellow toner image is transferred in the first unit 10Y, is successively transported through the second to fourth units 10M, 10C, and 10K while toner images of the respective colors are stacked on top of another.

The resulting intermediate transfer belt 20 on which toner images of four colors are multiple-transferred in the first to fourth units is then transported to a second transfer section including a support roller 24 contacting with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that contact with each other at the predetermined timing. The second transfer bias is then applied to the support roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not illustrated) that detects the resistance of the second transfer section and controlled by changing voltage.

Subsequently, the recording paper P is transported into a nip part of the fixing device (example of the fixing unit) 28 at which a pair of fixing rollers contact with each other. The toner image is fixed to the recording paper P to form a fixed image.

Examples of the recording paper P to which a toner image is transferred include plain paper used in electrophotographic copiers, printers, and the like. Instead of the recording paper P, OHP films and the like may be used as a recording medium.

The surface of the recording paper P may be smooth in order to enhance the smoothness of the surface of the fixed image. Examples of such a recording paper include coated paper produced by coating the surface of plain paper with resin or the like and art paper for printing.

The recording paper P, to which the color image has been fixed, is transported toward an exit portion. Thus, the series of the steps for forming a color image are terminated.

### Process Cartridge and Toner Cartridge

A process cartridge according to the exemplary embodiment is described below.

The process cartridge according to the exemplary embodiment includes a developing unit that includes the electrostatic image developer according to the exemplary embodiment and develops an electrostatic image formed on the surface of an image holding member with the electrostatic image developer to form a toner image. The process cartridge according to the exemplary embodiment is detachably attachable to an image forming apparatus.

The structure of the process cartridge according to the exemplary embodiment is not limited to the above-described one. The process cartridge according to the exemplary embodiment may further include, in addition to the developing device, at least one unit selected from an image holding member, a charging unit, an electrostatic image formation unit, a transfer unit, etc.

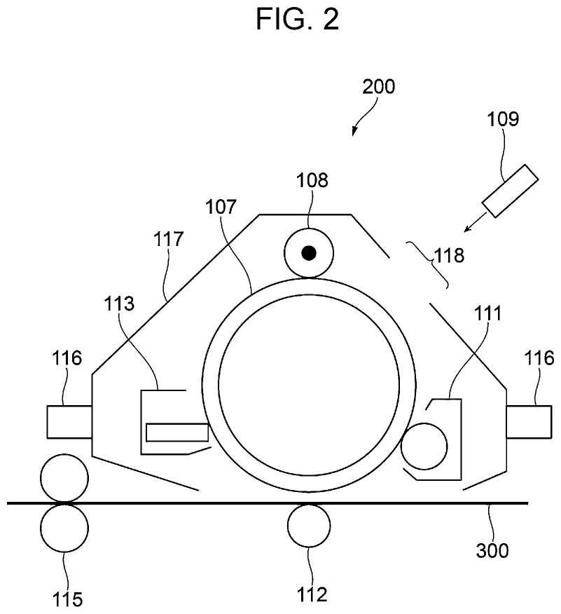

An example of the process cartridge according to the exemplary embodiment is described below, but the process cartridge is not limited thereto. Hereinafter, only components illustrated in FIG. 2 are described; others are omitted.

FIG. 2 schematically illustrates the process cartridge according to the exemplary embodiment.

A process cartridge 200 illustrated in FIG. 2 includes, for example, a photosensitive member 107 (example of the image holding member), a charging roller 108 (example of the charging unit) disposed on the periphery of the photosensitive member 107, a developing device 111 (example of the developing unit), and a photosensitive-member cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic image formation unit), Reference numeral 112 denotes a transfer device (example of the transfer unit), Reference numeral 115 denotes a fixing device (example of the fixing unit), and the Reference numeral 300 denotes recording paper (example of the recording medium).

A toner cartridge according to the exemplary embodiment is described below.

The toner cartridge according to the exemplary embodiment is a toner cartridge that includes the toner according to the exemplary embodiment and is detachably attachable to an image forming apparatus. The toner cartridge includes a replenishment toner that is to be supplied to the developing unit disposed inside an image forming apparatus.

The image forming apparatus illustrated in FIG. 1 is an image forming apparatus that includes the toner cartridges 8Y, 8M, 8C, and 8K detachably attached to the image forming apparatus. Each of the developing devices 4Y, 4M, 4C, and 4K is connected to a specific one of the toner cartridges which corresponds to the color of the developing device with a toner supply pipe (not illustrated). When the amount of toner contained in a toner cartridge is small, the toner cartridge is replaced.

### EXAMPLES

Examples are described below. It should be noted that the exemplary embodiments of the present disclosure are not limited by Examples. Hereinafter, all “part” and “%” are on a mass basis unless otherwise specified.

### Preparation of Amorphous Resin Particle Dispersion Liquids

### Preparation of Amorphous Polyester Resin Particle Dispersion Liquid (1)

Terephthalic acid: 28 molar parts
Isophthalic Acid (IPA): 15 molar parts
Adipic acid: 5 molar parts
Trimellitic anhydride: 2 molar parts
Bisphenol A propylene oxide 2 mol adduct: 50 molar parts

The above materials are charged into a reactor equipped with a stirring device, a nitrogen introduction tube, a temperature sensor, and a fractionating column. The temperature is increased to 190° C. over 1 hour. To 100 parts of the above materials, 1.2 parts of dibutyltin oxide is added. While the product water is distilled away, the temperature is increased to 240° C. over 6 hours. While the temperature is maintained at 240° C., the dehydration condensation reaction is continued for 3 hours and then cooling is performed. Hereby, an amorphous polyester resin (1) is prepared.

The amorphous polyester resin (1) has an acid value of 10.5 and a glass transition temperature of 59.0° C.
Amorphous polyester resin (1): 100 parts
Methyl ethyl ketone: 60 parts
Isopropanol: 10 parts
10% Aqueous ammonia solution: 3.5 parts

The above materials are charged into a jacketed reaction tank equipped with a condenser, a thermometer, a water dropper, and an anchor impeller. While the liquid temperature is maintained at 50° C. with a water circulation thermostat, the resin is dissolved by performing stirring at 100 rpm. Then, the temperature of the water circulation thermostat is set to 40° C., and 300 parts of ion-exchange water maintained at 40° C. is added dropwise at a rate of 3 part/min in total in order to perform phase inversion. Hereby, an emulsion is prepared. The emulsion is charged into an eggplant flask, which is connected to an evaporator equipped with a vacuum control unit with a trap ball interposed therebetween. While the eggplant flask is rotated, the temperature is increased in a hot-water bath at 60° C. With attention to bumping, the pressure is reduced to 7 kPa to remove the solvent. Subsequently, the pressure is increased to normal pressure and the eggplant flask is cooled with water. Hereby, a dispersion liquid is prepared. Ion-exchange water is added to the resulting dispersion liquid. Hereby, an amorphous polyester resin particle dispersion liquid (1) having a solid content of 20% by mass is prepared. The volume average size of the resin particles included in the amorphous polyester resin particle dispersion liquid (1) is 180 nm.

### Preparation of Amorphous Polyester Resin Particle Dispersion Liquid (2)

An amorphous polyester resin particle dispersion liquid (2) is prepared as in the preparation of the amorphous polyester resin particle dispersion liquid (1), except that the amount of terephthalic acid is changed from 28 molar parts to 43 molar parts and the amount of isophthalic acid (IPA) is changed from 15 molar parts to 0 molar part.

The amorphous polyester resin (2) has an acid value of 10.5 and a glass transition temperature of 62° C. The volume average size of the resin particles included in the amorphous polyester resin dispersion liquid (2) is 185 nm. The solid content in the amorphous polyester resin dispersion liquid (2) is 20%.

### Preparation of Amorphous Polyester Resin Particle Dispersion Liquid (3)

An amorphous polyester resin particle dispersion liquid (3) is prepared as in the preparation of the amorphous polyester resin particle dispersion liquid (1), except that the amount of terephthalic acid is changed from 28 molar parts to 20 molar parts and the amount of isophthalic acid (IPA) is changed from 15 molar parts to 23 molar parts.

The amorphous polyester resin (3) has an acid value of 10.5 and a glass transition temperature of 60° C. The volume average size of the resin particles included in the amorphous polyester resin dispersion liquid (3) is 183 nm. The solid content in the amorphous polyester resin dispersion liquid (3) is 20%.

### Preparation of Amorphous Polyester Resin Particle Dispersion Liquid (4)

An amorphous polyester resin particle dispersion liquid (4) is prepared as in the preparation of the amorphous polyester resin particle dispersion liquid (1), except that the amount of terephthalic acid is changed from 28 molar parts to 17 molar parts and the amount of isophthalic acid (IPA) is changed from 15 molar parts to 26 molar parts.

The amorphous polyester resin (4) has an acid value of 10.5 and a glass transition temperature of 55° C. The volume average size of the resin particles included in the amorphous polyester resin dispersion liquid (4) is 180 nm. The solid content in the amorphous polyester resin dispersion liquid (4) is 20%.

### Preparation of Amorphous Polyester Resin Particle Dispersion Liquid (5)

An amorphous polyester resin particle dispersion liquid (5) is prepared as in the preparation of the amorphous polyester resin particle dispersion liquid (1), except that the amount of terephthalic acid is changed from 28 molar parts to 37 molar parts and the amount of isophthalic acid (IPA) is changed from 15 molar parts to 6 molar parts.

The amorphous polyester resin (5) has an acid value of 10.5 and a glass transition temperature of 61° C. The volume average size of the resin particles included in the amorphous polyester resin dispersion liquid (5) is 187 nm. The solid content in the amorphous polyester resin dispersion liquid (5) is 20%.

### Preparation of Amorphous Polyester Resin Particle Dispersion Liquid (6)

An amorphous polyester resin particle dispersion liquid (6) is prepared as in the preparation of the amorphous polyester resin particle dispersion liquid (1), except that the amount of terephthalic acid is changed from 28 molar parts to 33 molar parts, the amount of adipic acid is changed from 5 parts to 0 part, and 50 molar parts of bisphenol A propylene oxide 2 mol adduct is changed to 50 molar parts of bisphenol A ethylene oxide 2 mol adduct.

The amorphous polyester resin (6) has an acid value of 11.0 and a glass transition temperature of 61° C. The volume average size of the resin particles included in the amorphous polyester resin dispersion liquid (6) is 185 nm. The solid content in the amorphous polyester resin dispersion liquid (6) is 20%.

### Preparation of Amorphous Polyester Resin Particle Dispersion Liquid (7)

Bisphenol A ethylene oxide 2.2 mol adduct: 40 molar parts
Bisphenol A propylene oxide 2.2 mol adduct: 60 molar parts
Dimethyl terephthalate: 60 molar parts
Dimethyl fumarate: 15 molar parts
Dodecenylsuccinic anhydride: 20 molar parts
Trimellitic anhydride: 5 molar parts

Into a reaction container equipped with a stirrer, a thermometer, a condenser, and a nitrogen gas introduction pipe, the above monomers except fumaric acid and trimellitic anhydride and 0.25 parts of tin dioctanoate relative to 100 parts of the total amount of the monomers are charged. After the reaction has been conducted for 6 hours at 235° C. in a nitrogen gas stream, the temperature is reduced to 200° C. and fumaric acid and trimellitic anhydride are charged into the reaction container. Then, the reaction is conducted for 1 hour. Subsequently, the temperature is increased to 220° C. over 5 hours. Polymerization is performed at a pressure of 10 kPa until the intended molecular weight is achieved. Hereby, a clear, pale yellow polyester resin (7) is prepared.

The polyester resin (7) has a glass transition temperature of 59° C.

The polyester resin (7) is dispersed with a disperser prepared by modifying “CAVITRON CD1010” (produced by EUROTEC) into a high-temperature, high-pressure type. The resulting dispersion liquid has a composition in which the proportion of ion-exchange water is 80% and the concentration of the polyester resin is 20%. The pH of the dispersion liquid is adjusted to 8.5 using ammonia. The CAVITRON is operated with the rotational speed of the rotor being 60 Hz at a pressure of 5 kg/cm², while heating is performed at 140° C. with a heat exchanger. Hereby, a polyester resin dispersion liquid (solid content: 20%) is prepared.

The volume average size of the resin particles included in the dispersion liquid is 130 nm. The solid content in the dispersion liquid is adjusted to 20% by the addition of ion-exchange water. Hereby, a polyester resin particle dispersion liquid (7) is prepared.

In Table 1, the amorphous polyester resin particle dispersion liquids (1) to (7) are abbreviated as “Amo 1” to “Amo 7”.

### Preparation of Crystalline Resin Dispersion Liquids

### Preparation of Crystalline Polyester Resin Particle Dispersion Liquid (1)

Dodecanedioic acid: 50 molar parts
1,6-Hexanediol: 50 molar parts

The above materials are charged into a reactor equipped with a stirring device, a nitrogen introduction tube, a temperature sensor, and a fractionating column. The temperature is increased to 160° C. over 1 hour. To 100 parts of the above materials, 0.8 parts of dibutyltin oxide is added. While the product water is distilled away, the temperature is increased to 180° C. over 6 hours. While the temperature is maintained at 180° C. and stirring is performed for 5 hours, the reaction is continued in the container under reflux. Subsequently, the temperature is gradually increased to 230° C. under reduced pressure (3 kPa). While the temperature is maintained at 230° C., stirring is performed for 2 hours. Then, the reaction product is cooled. After cooling, solid-liquid separation is performed to dry the solid substance. Hereby, a crystalline polyester resin (1) is prepared. The crystalline polyester resin (1) has a weight average molecular weight of 29,000.
Crystalline polyester resin (1): 100 parts
Methyl ethyl ketone: 70 parts
Isopropanol: 12 parts
10% Aqueous ammonia solution: 3 parts

The above materials are charged into a jacketed reaction tank equipped with a condenser, a thermometer, a water dropper, and an anchor impeller. While the liquid temperature is maintained at 80° C. with a water circulation thermostat, the resin is dissolved by performing stirring at 100 rpm. Then, the temperature of the water circulation thermostat is set to 60° C., and 300 parts of ion-exchange water maintained at 60° C. is added dropwise at a rate of 3 part/min in total in order to perform phase inversion. Hereby, an emulsion is prepared.

The emulsion is charged into an eggplant flask, which is connected to an evaporator equipped with a vacuum control unit with a trap ball interposed therebetween. While the eggplant flask is rotated, the temperature is increased in a hot-water bath at 60° C. With attention to bumping, the pressure is reduced to 7 kPa to remove the solvent. Subsequently, the pressure is increased to normal pressure and the eggplant flask is cooled with water. Hereby, a dispersion liquid is prepared. Ion-exchange water is added to the resulting dispersion liquid. Hereby, a crystalline polyester resin particle dispersion liquid (1) having a solid content of 20% is prepared. The volume average size of the resin particles included in the crystalline polyester resin particle dispersion liquid (1) is 160 nm.

### Preparation of Crystalline Polyester Resin Particle Dispersion Liquid (2)

Dodecanedioic acid: 50 molar parts
1,9-Nonanediol: 50 molar parts

Into a reaction container equipped with a stirrer, a thermometer, a condenser, and a nitrogen gas introduction pipe, the above monomers are charged. After the inside of the reaction container has been purged with a dry nitrogen gas, 0.25 parts of titanium tetrabutoxide is charged into the reaction container relative to 100 parts of the monomers. The reaction is conducted 3 hours at 170° C. in a nitrogen gas stream while stirring is performed. Then, the temperature is further increased to 210° C. over 1 hour. The pressure inside the reaction container is reduced to 3 kPa, and the reaction is conducted under the reduced pressure for 13 hours while stirring is performed. Hereby, a crystalline polyester resin (2) is prepared.

The crystalline polyester resin (2) has a weight average molecular weight of 25,000.

The crystalline polyester resin (2) is dispersed with a disperser prepared by modifying “CAVITRON CD1010” (produced by EUROTEC) into a high-temperature, high-pressure type. The resulting dispersion liquid has a composition in which the proportion of ion-exchange water is 80% and the concentration of the polyester resin is 20%. The pH of the dispersion liquid is adjusted to 8.5 using ammonia. The CAVITRON is operated with the rotational speed of the rotor being 60 Hz at a pressure of 5 kg/cm², while heating is performed at 140° C. with a heat exchanger. Hereby, a polyester resin dispersion liquid (solid content: 20%) is prepared.

The volume average size of the resin particles included in the dispersion liquid is 180 nm. The solid content in the dispersion liquid is adjusted to 20% by the addition of ion-exchange water. Hereby, a crystalline polyester resin particle dispersion liquid (2) is prepared.

In Table 1, the crystalline polyester resin particle dispersion liquids (1) and (2) are abbreviated as “Cry 1” and “Cry 2”.

### Preparation of Vinyl Resin Particle Dispersion Liquids

### Preparation of Vinyl Resin Particle Dispersion Liquid (1)

### Preparation of Emulsions (1-1) to (1-4)

### Emulsion (1-1)

Styrene: 60 parts
n-Butyl acrylate: 38.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (1-1).

### Emulsion (1-2)

Styrene: 55 parts
n-Butyl acrylate: 43.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (1-2).

### Emulsion (1-3)

Styrene: 45 parts
n-Butyl acrylate: 53.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (1-3).

### Emulsion (1-4)

Styrene: 40 parts
n-Butyl acrylate: 58.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (1-4).

### Vinyl Resin Particle Dispersion Liquid (1)

After the inside of a reactor equipped with a stirring device and a nitrogen introduction tube has been purged with nitrogen, 1.1 parts of an anionic surfactant (ELEMINOL MON-2) and 400 parts of ion-exchange water are added to the reactor. While being stirred, the resulting reaction solution is heated in an oil bath until the temperature of the reaction solution reaches 70° C. After 10 parts of the emulsion (1-1) has been added to the solution, 20 parts of an aqueous ammonium persulfate solution the concentration of which has been adjusted to 10% by mass is added to the solution. Subsequently, holding is performed for 30 minutes.

While the temperature of the reaction solution is maintained at 70° C., 190 parts of the emulsion (1-1) is gradually added dropwise to the reactor with a pump over 30 minutes. Then, 200 parts of the emulsion (1-2) is added dropwise to the reactor over 30 minutes. Subsequently, 200 parts of the emulsion (1-3) is added dropwise to the reactor over 40 minutes. Furthermore, 200 parts of the emulsion (1-4) is added dropwise to the reactor over 40 minutes.

Subsequent to the addition of the emulsions, holding is performed for 60 minutes. Then, 2 parts of ammonium persulfate having a concentration of 10% by mass is added to the reactor. After holding has been performed for another 3 hours, the temperature is reduced to room temperature. Subsequently, ion-exchange water and nitric acid are added to the reactor such that the solid content concentration reaches 20% by mass. Hereby, a vinyl resin particle dispersion liquid (1) is prepared.

The resulting resin particles have a volume average size of 165 nm. The glass transition temperature measured with a differential scanning calorimeter is 17° C.

### Preparation of Vinyl Resin Particle Dispersion Liquid (2)

A vinyl resin particle dispersion liquid (2) is prepared as in the preparation of the vinyl resin particle dispersion liquid (1), except that the amount of anionic surfactant (“ELEMINOL MON-2”) used is changed from 1.1 parts to 4.4 parts.

The resulting resin particles have a volume average size of 100 nm. The glass transition temperature measured with a differential scanning calorimeter is 17° C.

### Preparation of Vinyl Resin Particle Dispersion Liquid (3)

A vinyl resin particle dispersion liquid (3) is prepared as in the preparation of the vinyl resin particle dispersion liquid (1), except that the amount of anionic surfactant (“ELEMINOL MON-2”) used is changed from 1.1 parts to 0.6 parts.

The resulting resin particles have a volume average size of 200 nm. The glass transition temperature measured with a differential scanning calorimeter is 17° C.

### Preparation of Vinyl Resin Particle Dispersion Liquid (4)

A vinyl resin particle dispersion liquid (4) is prepared as in the preparation of the vinyl resin particle dispersion liquid (1), except that the amount of anionic surfactant (“ELEMINOL MON-2”) used is changed from 1.1 parts to 0.2 parts.

The resulting resin particles have a volume average size of 300 nm. The glass transition temperature measured with a differential scanning calorimeter is 17° C.

### Preparation of Vinyl Resin Particle Dispersion Liquid (5)

### Preparation of Emulsions (5-1) to (5-4)

### Emulsion (5-1)

Styrene: 47.6 parts
n-Butyl acrylate: 50.9 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (5-1).

### Emulsion (5-2)

Styrene: 43.7 parts
n-Butyl acrylate: 54.8 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (5-2).

### Emulsion (5-3)

Styrene: 35.7 parts
n-Butyl acrylate: 62.8 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (5-3).

### Emulsion (5-4)

Styrene: 31.8 parts
n-Butyl acrylate: 66.7 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (5-4).

### Vinyl Resin Particle Dispersion Liquid (5)

A vinyl resin particle dispersion liquid (5) is prepared as in the preparation of the vinyl resin particle dispersion liquid (1), except that the emulsions (1-1), (1-2), (1-3), and (1-4) are replaced with the emulsions (5-1), (5-2), (5-3), and (5-4), respectively.

The resulting resin particles have a volume average size of 165 nm. The glass transition temperature measured with a differential scanning calorimeter is 1° C.

### Preparation of Vinyl Resin Particle Dispersion Liquid (6)

### Preparation of Emulsions (6-1) to (6-4)

### Emulsion (6-1)

Styrene: 67.9 parts
n-Butyl acrylate: 30.6 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (6-1).

### Emulsion (6-2)

Styrene: 62.3 parts
n-Butyl acrylate: 36.2 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (6-2).

### Emulsion (6-3)

Styrene: 51.0 parts
n-Butyl acrylate: 47.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (6-3).

### Emulsion (6-4)

Styrene: 45.3 parts
n-Butyl acrylate: 53.2 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (6-4).

### Vinyl Resin Particle Dispersion Liquid (6)

A vinyl resin particle dispersion liquid (6) is prepared as in the preparation of the vinyl resin particle dispersion liquid (1), except that the emulsions (1-1), (1-2), (1-3), and (1-4) are replaced with the emulsions (6-1), (6-2), (6-3), and (6-4), respectively.

The resulting resin particles have a volume average size of 165 nm. The glass transition temperature measured with a differential scanning calorimeter is 29° C.

### Preparation of Vinyl Resin Particle Dispersion Liquid (7)

A vinyl resin particle dispersion liquid (7) is prepared as in the preparation of the vinyl resin particle dispersion liquid (1), except that the amount of anionic surfactant (“ELEMINOL MON-2”) used is changed from 1.1 parts to 0.18 parts.

The resulting resin particles have a volume average size of 310 nm. The glass transition temperature measured with a differential scanning calorimeter is 17° C.

### Preparation of Vinyl Resin Particle Dispersion Liquid (8)

A vinyl resin particle dispersion liquid (8) is prepared as in the preparation of the vinyl resin particle dispersion liquid (1), except that the amount of anionic surfactant (“ELEMINOL MON-2”) used is changed from 1.1 parts to 5.1 parts.

The resulting resin particles have a volume average size of 90 nm. The glass transition temperature measured with a differential scanning calorimeter is 17° C.

### Preparation of Vinyl Resin Particle Dispersion Liquid (9)

### Preparation of Emulsions (9-1) to (9-4)

### Emulsion (9-1)

Styrene: 70.1 parts
n-Butyl acrylate: 28.4 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (9-1).

### Emulsion (9-2)

Styrene: 64.3 parts
n-Butyl acrylate: 34.2 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (9-2).

### Emulsion (9-3)

Styrene: 52.6 parts
n-Butyl acrylate: 45.9 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (9-3).

### Emulsion (9-4)

Styrene: 46.8 parts
n-Butyl acrylate: 51.7 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (9-4).

### Vinyl Resin Particle Dispersion Liquid (9)

A vinyl resin particle dispersion liquid (9) is prepared as in the preparation of the vinyl resin particle dispersion liquid (1), except that the emulsions (1-1), (1-2), (1-3), and (1-4) are replaced with the emulsions (9-1), (9-2), (9-3), and (9-4), respectively.

The resulting resin particles have a volume average size of 165 nm. The glass transition temperature measured with a differential scanning calorimeter is 32° C.

### Preparation of Vinyl Resin Particle Dispersion Liquid (10)

### Preparation of Emulsions (10-1) to (10-4)

Emulsion (10-1)
Styrene: 43.5 parts
n-Butyl acrylate: 55.0 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (10-1).

### Emulsion (10-2)

Styrene: 38.5 parts
n-Butyl acrylate: 60.0 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (10-2).

### Emulsion (10-3)

Styrene: 33.6 parts
n-Butyl acrylate: 64.9 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (10-3).

### Emulsion (10-4)

Styrene: 28.6 parts
n-Butyl acrylate: 69.9 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (10-4).

### Vinyl Resin Particle Dispersion Liquid (10)

A vinyl resin particle dispersion liquid (10) is prepared as in the preparation of the vinyl resin particle dispersion liquid (1), except that the emulsions (1-1), (1-2), (1-3), and (1-4) are replaced with the emulsions (10-1), (10-2), (10-3), and (10-4), respectively.

The resulting resin particles have a volume average size of 165 nm. The glass transition temperature measured with a differential scanning calorimeter is −5° C.

### Preparation of Vinyl Resin Particle Dispersion Liquid (11)

### Preparation of Emulsions (11-1) to (11-4)

Emulsion (11-1)
Styrene: 60.9 parts
n-Butyl acrylate: 39.1 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (11-1).

### Emulsion (11-2)

Styrene: 55.8 parts
n-Butyl acrylate: 44.2 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (11-2).

### Emulsion (11-3)

Styrene: 45.7 parts
n-Butyl acrylate: 54.3 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (11-3).

### Emulsion (11-4)

Styrene: 40.6 parts
n-Butyl acrylate: 59.4 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (11-4).

### Vinyl Resin Particle Dispersion Liquid (11)

A vinyl resin particle dispersion liquid (11) is prepared as in the preparation of the vinyl resin particle dispersion liquid (1), except that the emulsions (1-1), (1-2), (1-3), and (1-4) are replaced with the emulsions (11-1), (11-2), (11-3), and (11-4), respectively.

The resulting resin particles have a volume average size of 165 nm. The glass transition temperature measured with a differential scanning calorimeter is 17° C.

### Preparation of Vinyl Resin Particle Dispersion Liquid (12)

### Preparation of Emulsions (12-1) to (12-4)

Emulsion (12-1)
Styrene: 40.0 parts
n-Butyl acrylate: 58.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (12-1).

### Emulsion (12-2)

Styrene: 45.0 parts
n-Butyl acrylate: 53.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (12-2).

### Emulsion (12-3)

Styrene: 55.0 parts
n-Butyl acrylate: 43.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (12-3).

### Emulsion (12-4)

Styrene: 60.0 parts
n-Butyl acrylate: 38.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (12-4).

### Vinyl Resin Particle Dispersion Liquid (12)

A vinyl resin particle dispersion liquid (12) is prepared as in the preparation of the vinyl resin particle dispersion liquid (1), except that the emulsions (1-1), (1-2), (1-3), and (1-4) are replaced with the emulsions (12-1), (12-2), (12-3), and (12-4), respectively.

The resulting resin particles have a volume average size of 165 nm. The glass transition temperature measured with a differential scanning calorimeter is 17° C.

### Preparation of Vinyl Resin Particle Dispersion Liquid (13)

### Preparation of Emulsions (13-1) to (13-4)

### Emulsion (13-1)

Styrene: 49.2 parts
n-Butyl acrylate: 49.3 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (13-1).

### Emulsion (13-2)

Styrene: 48.5 parts
n-Butyl acrylate: 50.0 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (13-2).

### Emulsion (13-3)

Styrene: 47.8 parts
n-Butyl acrylate: 50.7 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (13-3).

### Emulsion (13-4)

Styrene: 47.2 parts
n-Butyl acrylate: 51.3 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (13-4).

### Vinyl Resin Particle Dispersion Liquid (13)

A vinyl resin particle dispersion liquid (13) is prepared as in the preparation of the vinyl resin particle dispersion liquid (1), except that the emulsions (1-1), (1-2), (1-3), and (1-4) are replaced with the emulsions (13-1), (13-2), (13-3), and (13-4), respectively.

The resulting resin particles have a volume average size of 164 nm. The glass transition temperature measured with a differential scanning calorimeter is 15° C.

### Preparation of Vinyl Resin Particle Dispersion Liquid (14)

### Preparation of Emulsions (14-1) to (14-4)

### Emulsion (14-1)

Styrene: 53.0 parts
n-Butyl acrylate: 45.0 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (14-1).

### Emulsion (14-2)

Styrene: 51.0 parts
n-Butyl acrylate: 47.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (14-2).

### Emulsion (14-3)

Styrene: 49.0 parts
n-Butyl acrylate: 49.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (14-3).

### Emulsion (14-4)

Styrene: 47.0 parts
n-Butyl acrylate: 51.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (14-4).

### Vinyl Resin Particle Dispersion Liquid (14)

A vinyl resin particle dispersion liquid (14) is prepared as in the preparation of the vinyl resin particle dispersion liquid (1), except that the emulsions (1-1), (1-2), (1-3), and (1-4) are replaced with the emulsions (14-1), (14-2), (14-3), and (14-4), respectively.

The resulting resin particles have a volume average size of 166 nm. The glass transition temperature measured with a differential scanning calorimeter is 17° C.

### Preparation of Vinyl Resin Particle Dispersion Liquid (15)

### Preparation of Emulsions (15-1) to (15-4)

### Emulsion (15-1)

Styrene: 67.4 parts
n-Butyl acrylate: 31.1 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (15-1).

### Emulsion (15-2)

Styrene: 55.8 parts
n-Butyl acrylate: 42.7 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (15-2).

### Emulsion (15-3)

Styrene: 44.2 parts
n-Butyl acrylate: 54.3 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (15-3).

### Emulsion (15-4)

Styrene: 32.6 parts
n-Butyl acrylate: 65.9 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (15-4).

### Vinyl Resin Particle Dispersion Liquid (15)

A vinyl resin particle dispersion liquid (15) is prepared as in the preparation of the vinyl resin particle dispersion liquid (1), except that the emulsions (1-1), (1-2), (1-3), and (1-4) are replaced with the emulsions (15-1), (15-2), (15-3), and (15-4), respectively.

The resulting resin particles have a volume average size of 165 nm. The glass transition temperature measured with a differential scanning calorimeter is 17° C.

### Preparation of Vinyl Resin Particle Dispersion Liquid (16)

### Preparation of Emulsions (16-1) to (16-4)

### Emulsion (16-1)

Styrene: 71.1 parts
n-Butyl acrylate: 27.4 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (16-1).

### Emulsion (16-2)

Styrene: 57.0 parts
n-Butyl acrylate: 41.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (16-2).

### Emulsion (16-3)

Styrene: 43.0 parts
n-Butyl acrylate: 55.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (16-3).

### Emulsion (16-4)

Styrene: 28.9 parts
n-Butyl acrylate: 69.6 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (16-4).

### Vinyl Resin Particle Dispersion Liquid (16)

A vinyl resin particle dispersion liquid (16) is prepared as in the preparation of the vinyl resin particle dispersion liquid (1), except that the emulsions (1-1), (1-2), (1-3), and (1-4) are replaced with the emulsions (16-1), (16-2), (16-3), and (16-4), respectively.

The resulting resin particles have a volume average size of 165 nm. The glass transition temperature measured with a differential scanning calorimeter is 17° C.

### Preparation of Vinyl Resin Particle Dispersion Liquid (17)

### Preparation of Emulsions (17-1) to (17-4)

### Emulsion (17-1)

Styrene: 44.2 parts
n-Butyl acrylate: 54.3 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (17-1).

### Emulsion (17-2)

Styrene: 48.1 parts
n-Butyl acrylate: 50.4 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (17-2).

### Emulsion (17-3)

Styrene: 51.9 parts
n-Butyl acrylate: 46.6 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (17-3).

### Emulsion (17-4)

Styrene: 55.7 parts
n-Butyl acrylate: 42.8 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (17-4).

### Vinyl Resin Particle Dispersion Liquid (17)

A vinyl resin particle dispersion liquid (17) is prepared as in the preparation of the vinyl resin particle dispersion liquid (1), except that the emulsions (1-1), (1-2), (1-3), and (1-4) are replaced with the emulsions (17-1), (17-2), (17-3), and (17-4), respectively.

The resulting resin particles have a volume average size of 165 nm. The glass transition temperature measured with a differential scanning calorimeter is 18° C.

### Preparation of Vinyl Resin Particle Dispersion Liquid (18)

### Preparation of Emulsions (18-1) to (18-4)

### Emulsion (18-1)

Styrene: 48.3 parts
n-Butyl acrylate: 50.2 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (18-1).

### Emulsion (18-2)

Styrene: 49.4 parts
n-Butyl acrylate: 49.1 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (18-2).

### Emulsion (18-3)

Styrene: 50.5 parts
n-Butyl acrylate: 48.0 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (18-3).

### Emulsion (18-4)

Styrene: 51.6 parts
n-Butyl acrylate: 46.9 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (18-4).

Vinyl Resin Particle Dispersion Liquid (18) A vinyl resin particle dispersion liquid (18) is prepared as in the preparation of the vinyl resin particle dispersion liquid (1), except that the emulsions (1-1), (1-2), (1-3), and (1-4) are replaced with the emulsions (18-1), (18-2), (18-3), and (18-4), respectively.

The resulting resin particles have a volume average size of 166 nm. The glass transition temperature measured with a differential scanning calorimeter is 18° C.

### Preparation of Vinyl Resin Particle Dispersion Liquid (19)

### Preparation of Emulsions (19-1) to (19-4)

### Emulsion (19-1)

Styrene: 81.3 parts
n-Butyl acrylate: 17.2 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (19-1).

### Emulsion (19-2)

Styrene: 60.4 parts
n-Butyl acrylate: 38.1 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (19-2).

### Emulsion (19-3)

Styrene: 39.5 parts
n-Butyl acrylate: 59.0 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (19-3).

### Emulsion (19-4)

Styrene: 18.7 parts
n-Butyl acrylate: 79.8 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (19-4).

### Vinyl Resin Particle Dispersion Liquid (19)

A vinyl resin particle dispersion liquid (19) is prepared as in the preparation of the vinyl resin particle dispersion liquid (1), except that the emulsions (1-1), (1-2), (1-3), and (1-4) are replaced with the emulsions (19-1), (19-2), (19-3), and (19-4), respectively.

The resulting resin particles have a volume average size of 167 nm. The glass transition temperature measured with a differential scanning calorimeter is 18° C.

### Preparation of Vinyl Resin Particle Dispersion Liquid (20)

### Preparation of Emulsions (20-1) to (20-4)

### Emulsion (20-1)

Styrene: 85.6 parts
n-Butyl acrylate: 12.9 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (20-1).

### Emulsion (20-2)

Styrene: 61.8 parts
n-Butyl acrylate: 36.7 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (20-2).

### Emulsion (20-3)

Styrene: 38.1 parts
n-Butyl acrylate: 60.4 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (20-3).

### Emulsion (20-4)

Styrene: 14.3 parts
n-Butyl acrylate: 84.2 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (20-4).

### Vinyl Resin Particle Dispersion Liquid (20)

A vinyl resin particle dispersion liquid (20) is prepared as in the preparation of the vinyl resin particle dispersion liquid (1), except that the emulsions (1-1), (1-2), (1-3), and (1-4) are replaced with the emulsions (20-1), (20-2), (20-3), and (20-4), respectively.

The resulting resin particles have a volume average size of 165 nm. The glass transition temperature measured with a differential scanning calorimeter is 18° C.

### Preparation of Vinyl Resin Particle Dispersion Liquid (21)

### Preparation of Emulsions (21-1) to (21-4)

### Emulsion (21-1)

Styrene: 49.0 parts
n-Butyl acrylate: 49.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (21-1).

### Emulsion (21-2)

Styrene: 49.7 parts
n-Butyl acrylate: 48.8 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (21-2).

### Emulsion (21-3)

Styrene: 50.3 parts
n-Butyl acrylate: 48.2 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (21-3).

### Emulsion (21-4)

Styrene: 51.0 parts
n-Butyl acrylate: 47.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (21-4).

### Vinyl Resin Particle Dispersion Liquid (21)

A vinyl resin particle dispersion liquid (21) is prepared as in the preparation of the vinyl resin particle dispersion liquid (1), except that the emulsions (1-1), (1-2), (1-3), and (1-4) are replaced with the emulsions (21-1), (21-2), (21-3), and (21-4), respectively.

The resulting resin particles have a volume average size of 163 nm. The glass transition temperature measured with a differential scanning calorimeter is 17° C.

### Preparation of Vinyl Resin Particle Dispersion Liquid (22)

### Preparation of Emulsions (22-1) to (22-4)

### Emulsion (22-1)

Styrene: 47.0 parts
n-Butyl acrylate: 51.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (22-1).

### Emulsion (22-2)

Styrene: 49.0 parts
n-Butyl acrylate: 49.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (22-2).

### Emulsion (22-3)

Styrene: 51.0 parts
n-Butyl acrylate: 47.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (22-3).

### Emulsion (22-4)

Styrene: 53.0 parts
n-Butyl acrylate: 45.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (22-4).

### Vinyl Resin Particle Dispersion Liquid (22)

A vinyl resin particle dispersion liquid (22) is prepared as in the preparation of the vinyl resin particle dispersion liquid (1), except that the emulsions (1-1), (1-2), (1-3), and (1-4) are replaced with the emulsions (22-1), (22-2), (22-3), and (22-4), respectively.

The resulting resin particles have a volume average size of 167 nm. The glass transition temperature measured with a differential scanning calorimeter is 17° C.

### Preparation of Vinyl Resin Particle Dispersion Liquid (23)

### Preparation of Emulsions (23-1) to (23-4)

### Emulsion (23-1)

Styrene: 31.2 parts
n-Butyl acrylate: 67.3 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (23-1).

### Emulsion (23-2)

Styrene: 43.7 parts
n-Butyl acrylate: 54.8 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (23-2).

### Emulsion (23-3)

Styrene: 56.3 parts
n-Butyl acrylate: 42.2 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (23-3).

### Emulsion (23-4)

Styrene: 68.8 parts
n-Butyl acrylate: 29.7 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (23-4).

### Vinyl Resin Particle Dispersion Liquid (23)

A vinyl resin particle dispersion liquid (23) is prepared as in the preparation of the vinyl resin particle dispersion liquid (1), except that the emulsions (1-1), (1-2), (1-3), and (1-4) are replaced with the emulsions (23-1), (23-2), (23-3), and (23-4), respectively.

The resulting resin particles have a volume average size of 165 nm. The glass transition temperature measured with a differential scanning calorimeter is 17° C.

### Preparation of Vinyl Resin Particle Dispersion Liquid (24)

### Preparation of Emulsions (24-1) to (24-4)

### Emulsion (24-1)

Styrene: 23.5 parts
n-Butyl acrylate: 75.0 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (24-1).

### Emulsion (24-2)

Styrene: 38.7 parts
n-Butyl acrylate: 58.8 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (24-2).

### Emulsion (24-3)

Styrene: 54.0 parts
N-BUTYL ACRYLATE: 44.5 PARTS
1,10-DECANEDIOL DIACRYLATE: 1.5 PARTS
ANIONIC SURFACTANT (“ELEMINOL MON-2”): 1.2 PARTS
ION-EXCHANGE WATER: 98.8 PARTS

The above materials are charged into a mixing container equipped with a stirring device and the resulting mixture is stirred to form an emulsion (24-3).

### Emulsion (24-4)

Styrene: 69.2 parts
n-Butyl acrylate: 29.3 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (24-4).

### Vinyl Resin Particle Dispersion Liquid (24)

A vinyl resin particle dispersion liquid (24) is prepared as in the preparation of the vinyl resin particle dispersion liquid (1), except that the emulsions (1-1), (1-2), (1-3), and (1-4) are replaced with the emulsions (24-1), (24-2), (24-3), and (24-4), respectively.

The resulting resin particles have a volume average size of 164 nm. The glass transition temperature measured with a differential scanning calorimeter is 12° C.

### Preparation of Vinyl Resin Particle Dispersion Liquid (25)

### Preparation of Emulsions (25-1) to (25-4)

### Emulsion (25-1)

Styrene: 67.1 parts
n-Butyl acrylate: 31.4 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (25-1).

### Emulsion (25-2)

Styrene: 55.7 parts
n-Butyl acrylate: 42.8 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (25-2).

### Emulsion (25-3)

Styrene: 44.2 parts
n-Butyl acrylate: 54.3 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (25-3).

### Emulsion (25-4)

Styrene: 32.8 parts
n-Butyl acrylate: 65.7 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (25-4).

### Vinyl Resin Particle Dispersion Liquid (25)

A vinyl resin particle dispersion liquid (25) is prepared as in the preparation of the vinyl resin particle dispersion liquid (1), except that the emulsions (1-1), (1-2), (1-3), and (1-4) are replaced with the emulsions (25-1), (25-2), (25-3), and (25-4), respectively.

The resulting resin particles have a volume average size of 166 nm. The glass transition temperature measured with a differential scanning calorimeter is 18° C.

### Preparation of Vinyl Resin Particle Dispersion Liquid (26)

### Preparation of Emulsions (26-1) to (26-4)

### Emulsion (26-1)

Styrene: 63.4 parts
n-Butyl acrylate: 35.1 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (26-1).

### Emulsion (26-2)

Styrene: 54.4 parts
n-Butyl acrylate: 44.1 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (26-2).

### Emulsion (26-3)

Styrene: 45.5 parts
n-Butyl acrylate: 53.0 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (26-3).

### Emulsion (26-4)

Styrene: 36.6 parts
n-Butyl acrylate: 61.9 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (26-4).

### Vinyl Resin Particle Dispersion Liquid (26)

A vinyl resin particle dispersion liquid (26) is prepared as in the preparation of the vinyl resin particle dispersion liquid (1), except that the emulsions (1-1), (1-2), (1-3), and (1-4) are replaced with the emulsions (26-1), (26-2), (26-3), and (26-4), respectively.

The resulting resin particles have a volume average size of 165 nm. The glass transition temperature measured with a differential scanning calorimeter is 18° C.

### Preparation of Vinyl Resin Particle Dispersion Liquid (27)

### Preparation of Emulsions (27-1) to (27-4)

### Emulsion (27-1)

Styrene: 27.6 parts
n-Butyl acrylate: 70.9 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (27-1).

### Emulsion (27-2)

Styrene: 42.5 parts
n-Butyl acrylate: 56.0 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (27-2).

### Emulsion (27-3)

Styrene: 57.4 parts
n-Butyl acrylate: 41.1 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (27-3).

### Emulsion (27-4)

Styrene: 72.4 parts
n-Butyl acrylate: 26.1 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (27-4).

### Vinyl Resin Particle Dispersion Liquid (27)

A vinyl resin particle dispersion liquid (27) is prepared as in the preparation of the vinyl resin particle dispersion liquid (1), except that the emulsions (1-1), (1-2), (1-3), and (1-4) are replaced with the emulsions (27-1), (27-2), (27-3), and (27-4), respectively.

The resulting resin particles have a volume average size of 164 nm. The glass transition temperature measured with a differential scanning calorimeter is 18° C.

### Preparation of Vinyl Resin Particle Dispersion Liquid (28)

### Preparation of Emulsions (28-1) to (28-4)

### Emulsion (28-1)

Styrene: 22.0 parts
n-Butyl acrylate: 76.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (28-1).

### Emulsion (28-2)

Styrene: 40.6 parts
n-Butyl acrylate: 57.9 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (28-2).

### Emulsion (28-3)

Styrene: 59.3 parts
n-Butyl acrylate: 39.2 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (28-3).

### Emulsion (28-4)

Styrene: 78.0 parts
n-Butyl acrylate: 20.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (28-4).

### Vinyl Resin Particle Dispersion Liquid (28)

A vinyl resin particle dispersion liquid (28) is prepared as in the preparation of the vinyl resin particle dispersion liquid (1), except that the emulsions (1-1), (1-2), (1-3), and (1-4) are replaced with the emulsions (28-1), (28-2), (28-3), and (28-4), respectively.

The resulting resin particles have a volume average size of 166 nm. The glass transition temperature measured with a differential scanning calorimeter is 18° C.

### Preparation of Vinyl Resin Particle Dispersion Liquid (29)

### Preparation of Emulsions (29-1) to (29-4)

### Emulsion (29-1)

Styrene: 57.8 parts
n-Butyl acrylate: 40.7 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (29-1).

### Emulsion (29-2)

Styrene: 53.0 parts
n-Butyl acrylate: 45.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (29-2).

### Emulsion (29-3)

Styrene: 43.3 parts
n-Butyl acrylate: 55.2 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (29-3).

### Emulsion (29-4)

Styrene: 38.5 parts
n-Butyl acrylate: 60.0 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (29-4).

### Vinyl Resin Particle Dispersion Liquid (29)

A vinyl resin particle dispersion liquid (29) is prepared as in the preparation of the vinyl resin particle dispersion liquid (1), except that the emulsions (1-1), (1-2), (1-3), and (1-4) are replaced with the emulsions (29-1), (29-2), (29-3), and (29-4), respectively, and the amount of the anionic surfactant used (“ELEMINOL MON-2”) is changed from 1.1 parts to 2.7 parts.

The resulting resin particles have a volume average size of 120 nm. The glass transition temperature measured with a differential scanning calorimeter is 15° C.

### Preparation of Vinyl Resin Particle Dispersion Liquid (30)

Styrene: 77 parts
n-Butyl acrylate: 23 parts
1,10-Decanediol diacrylate: 0.4 parts Dodecanethiol: 0.7 parts

The above materials are mixed with one another to form a solution. To the solution, a solution prepared by dissolving 1.0 parts of an anionic surfactant (“Dowfax” produced by The Dow Chemical Company) in 60 parts of ion-exchange water is added. Then, dispersion and emulsification are performed in a flask. Hereby, an emulsion is prepared.

Subsequently, 3 parts of an anionic surfactant (“Dowfax” produced by The Dow Chemical Company) is dissolved in 90 parts of ion-exchange water, and 30 parts of the emulsion is added to the resulting solution. To the solution, 10 parts of ion-exchange water containing 1.0 parts of ammonium persulfate dissolved therein is further charged.

Then, the remaining part of the emulsion is charged into the flask over 3 hours. After the inside of the flask has been purged with nitrogen, while the solution contained in the flask is stirred, the temperature is increased to 65° C. in an oil bath. Subsequently, emulsion polymerization is continued for 5 hours. Hereby, a vinyl resin particle dispersion liquid (30) is prepared. The solid content in the vinyl resin particle dispersion liquid (30) is adjusted to 32% by the addition of ion-exchange water as needed.

In Table 1, the vinyl resin particle dispersion liquids (1) to (30) are abbreviated as “Vinyl 1” to “Vinyl 30”.

### Preparation of Rubber Particle Dispersion Liquid

### Preparation of Styrene Butadiene Rubber Particle Dispersion Liquid (1)

Into a polymerization reaction container, 400 parts of ion-exchange water, 100 parts of styrene, 80 parts of butadiene, 24 parts of methyl acrylate, 8 parts of acrylic acid, 6 parts of potassium persulfate, and 3 parts of n-dodecyl mercaptan are charged. Subsequently, polymerization is performed for 5 hours at 85° C. in a nitrogen atmosphere. After the reaction has been continued for 2 hours, polymerization is terminated. The solid content in the resulting dispersion liquid is adjusted to 20%. Hereby, a rubber particle dispersion liquid is prepared. The rubber particles have a glass transition temperature of −20° C. and a volume average size of 180 nm.

In Table 1, the styrene butadiene rubber particle dispersion liquid (1) is abbreviated as “Rubber 1”.

### Preparation of Colorant Dispersion Liquids

### Preparation of Colorant Dispersion Liquid (1)

Cyan pigment (Pigment Blue 15:3 (copper phthalocyanine) produced by Dainichiseika Color & Chemicals Mfg. Co., Ltd.): 98 parts
Anionic surfactant (“NEOPELEX G-65” produced by Kao Corporation): 2 parts
Ion-exchange water: 400 parts

The above components are mixed with one another, and the resulting mixture is dispersed with a homogenizer (“ULTRA-TURRAX T50” produced by IKA) to form a colorant dispersion liquid (1) having a volume average size of 160 nm and a solid content of 20%.

### Preparation of Colorant Dispersion Liquid (2)

Carbon black (“Regal330” produced by Cabot Corporation): 98 parts
Anionic surfactant (“NEOPELEX G-65” produced by Kao Corporation): 2 parts
Ion-exchange water: 400 parts

The above components are mixed with one another, and the resulting mixture is dispersed with a homogenizer (“ULTRA-TURRAX T50” produced by IKA) to form a colorant dispersion liquid (2) having a volume average size of 180 nm and a solid content of 20%.

### Preparation of Colorant Dispersion Liquid (3)

Carbon black (“Regal330” produced by Cabot Corporation): 250 parts
Anionic surfactant (“NEOGEN SC” produced by DKS Co. Ltd.): 33 parts (active component: 60%, 8% relative to the colorant)
Ion-exchange water: 750 parts

Into a stainless steel container having a volume such that, when all the components are charged into the container, the liquid level of the container reaches about ⅓ of the height of the container, 280 parts of ion-exchange water and 33 parts of the anionic surfactant are charged. After the surfactant has been dissolved in water to a sufficient degree, the whole amount of the solid pigment is charged into the container, and the resulting mixture is stirred with a stirrer until all of the pigment particles become wet, while degassing is performed to a sufficient degree. Subsequent to the degassing, the remaining part of the ion-exchange water is added to the container. After dispersion has been performed with a homogenizer (“ULTRA-TURRAX T50” produced by IKA) at 5,000 rotations for 10 minutes, stirring is performed with a stirrer a whole day and night to perform degassing. Subsequent to the degassing, dispersion is again performed with a homogenizer at 6,000 rotations for 10 minutes. Then, stirring is performed with a stirrer a whole day and night to perform degassing. Subsequently, the dispersion liquid is dispersed at a pressure of 240 MPa with a high-pressure impact disperser Ultimaizer (“HJP30006” produced by Sugino Machine Limited). Dispersion is performed for 25 paths in accordance with the total amount of materials charged and the treatment capacity of the device. The resulting dispersion liquid is left to stand for 72 hours in order to remove the precipitates. Then, ion-exchange water is added to the dispersion liquid to adjust the solid content in the dispersion liquid to 15%. hereby, a colorant particle dispersion liquid (3) is prepared. The volume average size D50 of the particles included in the colorant particle dispersion liquid (3) is 135 nm.

In Table 1, the colorant dispersion liquids (1), (2), and (3) are abbreviated as “Cyan 1”, “Black 1”, and “Black 2”, respectively.

### Preparation of Release Agent Dispersion Liquids

### Preparation of Release Agent Dispersion Liquid (1)

Synthetic wax (“FT100” produced by Nippon Seiro Co., Ltd.): 100 parts
Anionic surfactant (“NEOPELEX G-65” produced by Kao Corporation): 5 parts
Ion-exchange water: 300 parts

The above components are mixed with one another, and the resulting mixture is heated to 100° C. and dispersed with a homogenizer (“ULTRA-TURRAX T50” produced by IKA). Further dispersion treatment is performed with a Manton-Gaulin high pressure homogenizer (produced by Gaulin). Ion-exchange water is added to the resulting dispersion liquid. Hereby, a release agent dispersion liquid (1) having a solid content of 20% is prepared.

The volume average size of the release agent particles included in the release agent dispersion liquid (1) is 230 nm.

### Preparation of Release Agent Dispersion Liquid (2)

Polyethylene wax (hydrocarbon wax: “POLYWAX 725” produced by Baker Petrolite Corporation, melting temperature: 104° C.): 270 parts
Anionic surfactant (“NEOGEN RK” produced by Dai-ichi Kogyo Seiyaku Co., Ltd., active component: 60%): 13.5 parts (as an active component, 3.0% relative to release agent)
Ion-exchange water: 21.6 parts

The above components are mixed with one another, and the resulting mixture is subjected to a pressure-discharge-type homogenizer (“Gaulin Homogenizer” produced by Gaulin) at a liquid temperature of 120° C. in order to dissolve the release agent. Subsequently, dispersion is performed at a pressure of 5 MPa for 120 minutes and at 40 MPa for another 360 minutes. Then, the dispersion liquid is cooled. Hereby, a release agent dispersion liquid (2) is prepared. The volume average size D50 of the particles included in the release agent dispersion liquid (2) is 225 nm. The solid content in the release agent dispersion liquid (2) is adjusted to 20.0% by the addition of ion-exchange water.

In Table 1, the release agent dispersion liquids (1) and (2) are abbreviated as “WAX 1” and “WAX 2”.

### Preparation of Mixed Particle Dispersion Liquid (1): Included in Toner 47 Prepared in Comparative Examples 5

With 400 parts of the amorphous polyester resin particle dispersion liquid (7), 60 parts of the release agent dispersion liquid (2) and 2.9 parts of an anionic surfactant (“Dowfax2A1” produced by The Dow Chemical Company) are mixed. The pH of the resulting mixture is adjusted to 3.0 by the addition of 1.0% nitric acid at 25° C. Hereby, a mixed particle dispersion liquid (1) is prepared.

### Example 1

### Preparation of Toner (1)

Amorphous polyester resin particle dispersion liquid (1) (solid content: 20% by mass): 492 parts
Crystalline polyester resin particle dispersion liquid (1) (solid content: 20% by mass): 228 parts
Colorant dispersion liquid (1) (solid content: 20% by mass): 90 parts
Release agent dispersion liquid (1) (solid content: 20% by mass): 120 parts
Anionic surfactant (“ELEMINOL MON-2”): 10.5 parts
Ion-exchange water: 750 parts

The above components are charged into a 3-liter reaction container equipped with a thermometer, a pH meter, a stirrer, and an impeller having a diameter of 20 cm. While the temperature of the reaction container is maintained at 20° C. and the resulting mixture is stirred at a rotational speed of 35 rpm, holding is performed for 30 minutes. Subsequently, the pH of the mixture is adjusted to 4.5 by the addition of a 0.3-N aqueous nitric acid solution.

Subsequently, 150.0 parts of the vinyl resin particle dispersion liquid (1) (solid content: 20% by mass) is charged into a container equipped with a stirrer and an impeller. The pH of the dispersion liquid is adjusted to 4.5 while the dispersion liquid is stirred.

Then, while the temperature of the 3-liter reaction container is maintained at 20° C. and stirring is performed at a rotational speed of 35 rpm, the vinyl resin particle dispersion liquid (1) that has been subjected to the pH adjustment is added dropwise to the reaction container at a rate of 7 g/min.

Subsequently, while dispersion is performed with a homogenizer (“ULTRA-TURRAX T50”), a 2% aqueous aluminum sulfate solution is added to the reaction container. Subsequently, while stirring is performed, the temperature is increased to 45° C. at a rate of 0.4° C./min and holding is performed for 30 minutes.

Then, 420 parts of the amorphous polyester resin particle dispersion liquid (1) is added to the resulting mixture, and holding is performed for 30 minutes. Subsequently, a 0.1 N aqueous sodium hydroxide solution is added to the mixture in order to adjust the pH to 8.5. After holding has been performed for 15 minutes, while stirring is continued, the temperature is increased to 80° C. at a rate of 1° C./min and holding is performed at 80° C. for 5 hours. Then, cooling and solid-liquid separation are performed. The resulting solid substance is washed with ion-exchange water and then dried with a vacuum freeze dryer for 24 hours. Hereby, toner particles (1) having a volume average size of 5.5 μm are prepared.

With 100 parts of the toner particles (1), 2.0 parts of hydrophobic silica (“RY200” produced by Nippon Aerosil Co., Ltd.) is mixed using a Henschel Mixer. Hereby, a toner 1 is prepared.

### Example 2

A toner 2 is prepared as in Example 1, except that the vinyl resin particle dispersion liquid (2) is used instead of the vinyl resin particle dispersion liquid (1).

### Example 3

A toner 3 is prepared as in Example 1, except that the amount of amorphous polyester resin particle dispersion liquid (1) is changed from 492 parts to 552 parts, the amount of crystalline polyester resin particle dispersion liquid (1) is changed from 228 parts to 243 parts, and 75 parts of the vinyl resin particle dispersion liquid (3) is used instead of 150.0 parts of the vinyl resin particle dispersion liquid (1).

### Example 4

A toner 4 is prepared as in Example 1, except that the amount of amorphous polyester resin particle dispersion liquid (1) is changed from 492 parts to 420 parts, the amount of crystalline polyester resin particle dispersion liquid (1) is changed from 228 parts to 210 parts, and 240 parts of the vinyl resin particle dispersion liquid (4) is used instead of 150.0 parts of the vinyl resin particle dispersion liquid (1).

### Example 5

A toner 5 is prepared as in Example 1, except that the vinyl resin particle dispersion liquid (5) is used instead of the vinyl resin particle dispersion liquid (1).

### Example 6

A toner 6 is prepared as in Example 1, except that the vinyl resin particle dispersion liquid (6) is used instead of the vinyl resin particle dispersion liquid (1).

### Example 7

A toner 7 is prepared as in Example 1, except that the amount of amorphous polyester resin particle dispersion liquid (1) is changed from 492 parts to 384 parts, the amount of crystalline polyester resin particle dispersion liquid (1) is changed from 228 parts to 201 parts, and 285 parts of the vinyl resin particle dispersion liquid (3) is used instead of 150.0 parts of the vinyl resin particle dispersion liquid (1).

### Example 8

A toner 8 is prepared as in Example 1, except that the amount of amorphous polyester resin particle dispersion liquid (1) is changed from 492 parts to 396 parts, the amount of crystalline polyester resin particle dispersion liquid (1) is changed from 228 parts to 204 parts, and 270 parts of the vinyl resin particle dispersion liquid (7) is used instead of 150.0 parts of the vinyl resin particle dispersion liquid (1).

### Example 9

A toner 9 is prepared as in Example 1, except that the amount of amorphous polyester resin particle dispersion liquid (1) is changed from 492 parts to 516 parts, the amount of crystalline polyester resin particle dispersion liquid (1) is changed from 228 parts to 234 parts, and 120 parts of the vinyl resin particle dispersion liquid (8) is used instead of 150.0 parts of the vinyl resin particle dispersion liquid (1).

### Example 10

A toner 10 is prepared as in Example 1, except that the amount of amorphous polyester resin particle dispersion liquid (1) is changed from 492 parts to 560.4 parts, the amount of crystalline polyester resin particle dispersion liquid (1) is changed from 228 parts to 245.1 parts, and the amount of vinyl resin particle dispersion liquid (1) is changed from 150.0 parts to 64.5 parts.

### Example 11

A toner 11 is prepared as in Example 1, except that the amount of amorphous polyester resin particle dispersion liquid (1) is changed from 492 parts to 372 parts, the amount of crystalline polyester resin particle dispersion liquid (1) is changed from 228 parts to 198 parts, and 300 parts of the vinyl resin particle dispersion liquid (3) is used instead of 150.0 parts of the vinyl resin particle dispersion liquid (1).

### Example 12

A toner 12 is prepared as in Example 1, except that the vinyl resin particle dispersion liquid (9) is used instead of the vinyl resin particle dispersion liquid (1).

### Example 13

A toner 13 is prepared as in Example 1, except that the vinyl resin particle dispersion liquid (10) is used instead of the vinyl resin particle dispersion liquid (1).

### Example 14

A toner 14 is prepared as in Example 1, except that the amount of amorphous polyester resin particle dispersion liquid (1) is changed from 492 parts to 720 parts and the amount of crystalline polyester resin particle dispersion liquid (1) is changed from 228 parts to 0 part.

### Example 15

A toner 15 is prepared as in Example 1, except that the amount of amorphous polyester resin particle dispersion liquid (1) is changed from 492 parts to 702 parts and the amount of the amorphous polyester resin particles added after the temperature has been increased to 45° C. is changed from 420 parts to 210 parts.

### Example 16

A toner 16 is prepared as in Example 1, except that the amount of amorphous polyester resin particle dispersion liquid (1) is changed from 492 parts to 792 parts and the amount of the amorphous polyester resin particles added after the temperature has been increased to 45° C. is changed from 420 parts to 120 parts.

### Example 17

A toner 17 is prepared as in Example 1, except that the rotational speed at which stirring is performed when the materials are mixed with one another is changed from 35 rpm to 45 rpm and the pH value to which the pH of the vinyl resin particle dispersion liquid (1) is adjusted is changed from 4.5 to 4.7.

### Example 18

A toner 18 is prepared as in Example 1, except that the rotational speed at which stirring is performed when the materials are mixed with one another is changed from 35 rpm to 54 rpm and the vinyl resin particle dispersion liquid (4) is used instead of the vinyl resin particle dispersion liquid (1).

### Example 19

A toner 19 is prepared as in Example 1, except that the colorant dispersion liquid (2) is used instead of the colorant dispersion liquid (1).

### Example 20

A toner 20 is prepared as in Example 1, except that the amorphous polyester resin particle dispersion liquid (2) is used instead of the amorphous polyester resin particle dispersion liquid (1).

### Example 21

A toner 21 is prepared as in Example 1, except that the vinyl resin particle dispersion liquid (11) is used instead of the vinyl resin particle dispersion liquid (1).

### Example 22

A toner 22 is prepared as in Example 1, except that the vinyl resin particle dispersion liquid (12) is used instead of the vinyl resin particle dispersion liquid (1).

### Example 23

A toner 23 is prepared as in Example 1, except that the amorphous polyester resin particle dispersion liquid (3) is used instead of the amorphous polyester resin particle dispersion liquid (1).

### Example 24

A toner 24 is prepared as in Example 1, except that the amorphous polyester resin particle dispersion liquid (4) is used instead of the amorphous polyester resin particle dispersion liquid (1).

### Example 25

A toner 25 is prepared as in Example 1, except that the amorphous polyester resin particle dispersion liquid (5) is used instead of the amorphous polyester resin particle dispersion liquid (1).

### Example 26

A toner 26 is prepared as in Example 1, except that the vinyl resin particle dispersion liquid (13) is used instead of the vinyl resin particle dispersion liquid (1).

### Example 27

A toner 27 is prepared as in Example 1, except that the vinyl resin particle dispersion liquid (14) is used instead of the vinyl resin particle dispersion liquid (1).

### Example 28

A toner 28 is prepared as in Example 1, except that the vinyl resin particle dispersion liquid (15) is used instead of the vinyl resin particle dispersion liquid (1).

### Example 29

A toner 29 is prepared as in Example 1, except that the vinyl resin particle dispersion liquid (16) is used instead of the vinyl resin particle dispersion liquid (1).

### Example 30

A toner 30 is prepared as in Example 1, except that the vinyl resin particle dispersion liquid (17) is used instead of the vinyl resin particle dispersion liquid (1).

### Example 31

A toner 31 is prepared as in Example 1, except that the vinyl resin particle dispersion liquid (18) is used instead of the vinyl resin particle dispersion liquid (1).

### Example 32

A toner 32 is prepared as in Example 1, except that the vinyl resin particle dispersion liquid (19) is used instead of the vinyl resin particle dispersion liquid (1).

### Example 33

A toner 33 is prepared as in Example 1, except that the vinyl resin particle dispersion liquid (20) is used instead of the vinyl resin particle dispersion liquid (1).

### Example 34

A toner 34 is prepared as in Example 1, except that the vinyl resin particle dispersion liquid (21) is used instead of the vinyl resin particle dispersion liquid (1).

### Example 35

A toner 35 is prepared as in Example 1, except that the vinyl resin particle dispersion liquid (22) is used instead of the vinyl resin particle dispersion liquid (1).

### Example 36

A toner 36 is prepared as in Example 1, except that the vinyl resin particle dispersion liquid (23) is used instead of the vinyl resin particle dispersion liquid (1).

### Example 37

A toner 37 is prepared as in Example 1, except that the vinyl resin particle dispersion liquid (24) is used instead of the vinyl resin particle dispersion liquid (1).

### Example 38

A toner 38 is prepared as in Example 1, except that the vinyl resin particle dispersion liquid (25) is used instead of the vinyl resin particle dispersion liquid (1).

### Example 39

A toner 39 is prepared as in Example 1, except that the vinyl resin particle dispersion liquid (26) is used instead of the vinyl resin particle dispersion liquid (1).

### Example 40

A toner 40 is prepared as in Example 1, except that the vinyl resin particle dispersion liquid (27) is used instead of the vinyl resin particle dispersion liquid (1).

### Example 41

A toner 41 is prepared as in Example 1, except that the vinyl resin particle dispersion liquid (28) is used instead of the vinyl resin particle dispersion liquid (1).

### Example 42

A toner 42 is prepared as in Example 1, except that the amorphous polyester resin particle dispersion liquid (6) is used instead of the amorphous polyester resin particle dispersion liquid (1).

### Comparative Example 1

A toner 43 is prepared as in Example 1, except that the amount of amorphous polyester resin particle dispersion liquid (1) is changed from 492 parts to 390 parts, the amount of crystalline polyester resin particle dispersion liquid (1) is changed from 228 parts to 202.5 parts, and 277.5 parts of the vinyl resin particle dispersion liquid (29) is used instead of 150.0 parts of the vinyl resin particle dispersion liquid (1).

### Comparative Example 2

A toner 44 is prepared as in Example 1, except that the amount of amorphous polyester resin particle dispersion liquid (1) is changed from 492 parts to 498 parts, the amount of crystalline polyester resin particle dispersion liquid (1) is changed from 228 parts to 229.5 parts, and 142.5 parts of the vinyl resin particle dispersion liquid (29) is used instead of 150.0 parts of the vinyl resin particle dispersion liquid (1).

### Comparative Example 3

A toner 45 is prepared as in Example 1, except that the rotational speed at which stirring is performed when the materials are mixed with one another is changed from 35 rpm to 100 rpm and the pH value to which the pH of the vinyl resin particle dispersion liquid (1) is adjusted is changed from 4.5 to 5.2.

### Comparative Example 4

A toner 46 is prepared as in Example 1, except that the styrene butadiene rubber particle dispersion liquid (1) is used instead of the vinyl resin particle dispersion liquid (1).

### Comparative Example 5

Amorphous polyester resin particle dispersion liquid (7): 700 parts
Crystalline polyester resin particle dispersion liquid (2): 50 parts
Vinyl resin particle dispersion liquid (30): 205 parts
Colorant dispersion liquid (3): 133 parts
Release agent dispersion liquid (2): 15 parts
Ion-exchange water: 600 parts
Anionic surfactant (“Dowfax2A1” produced by The Dow Chemical Company): 2.9 parts

The above materials are charged into a 3-liter reaction container equipped with a thermometer, a pH meter, and a stirrer. After the pH of the resulting mixture has been adjusted to 3.0 by the addition of 1.0% nitric acid at 25° C., while dispersion is performed with a homogenizer (“ULTRA-TURRAX T50” produced by IKA) at 3000 rpm, 100 parts of an aqueous aluminum sulfate solution having a concentration of 2% is added to the reaction container.

Since the viscosity of the raw material dispersion liquid quickly increases while the coagulant is added dropwise to the reaction container, the rate at which the coagulant is added dropwise to the reaction container is reduced upon the increase in viscosity in order to prevent the coagulant from accumulating at the same position. After the addition of the coagulant has been terminated, the rotational speed is increased to 5,000 rpm and stirring is further performed for another 5 minutes.

Subsequently, a stirrer and a heating mantle are placed in the reaction container. While the rotational speed of the stirrer is adjusted such that the slurry can be stirred to a sufficient degree, the temperature is increased to 40° C. at a heating rate of 0.2° C./min and from 40° C. to 53° C. at a heating rate of 0.05° C./min. The particle sizes are measured with “MULTISIZER II” (aperture diameter: 50 μm, produced by Beckman Coulter, Inc.) every 10 minutes. When the volume average particle size reaches 5.0 μm, the temperature is maintained and 460 parts of the mixed particle dispersion liquid (1) is charged into the reaction container over 5 minutes.

After the temperature has been maintained at 50° C. for 30 minutes, in order to stop the growth of the aggregated particles including a coating layer, 8 parts of a 20% ethylenediaminetetraacetic acid (EDTA) solution is added to the reaction container. Then, a 1-mol/liter aqueous sodium hydroxide solution is added to the reaction container in order to adjust the pH of the raw material dispersion liquid to 9.0. Subsequently, the temperature is increased to 90° C. at a heating rate of 1° C./min while the pH of the dispersion liquid is adjusted to 9.0 at intervals of 5° C., and holding is performed at 90° C. When the dispersion liquid is inspected for particle shape and surface quality with an optical microscope and a field emission electron scanning microscope (FE-SEM), the coalescence of particles is confirmed after the lapse of 6 hours. Then, the container is cooled to 30° C. over 5 minutes using cooling water.

The cooled slurry is passed through a nylon mesh having an opening of 15 μm in order to remove coarse powder particles. The toner slurry that has passed through the mesh is subjected to vacuum filtration with an aspirator. The solid component that remains on the filter paper is crushed into as small particles as possible by fingers and charged into an amount of ion-exchange water ten times the amount of the solid component at 30° C. Then, stirring is performed for 30 minutes. Subsequently, vacuum filtration is performed with an aspirator, and the solid component that remains on the filter paper is crushed into as small particles as possible by fingers and charged into an amount of ion-exchange water ten times the amount of the solid component at 30° C. Then, stirring is performed for 30 minutes. Subsequently, vacuum filtration is again performed with an aspirator, and the electric conductivity of the filtrate is measured. The above operation is repeated until the electric conductivity of the filtrate reaches 10 S/cm or less in order to clean the solid component.

The cleaned solid component is pulverized with a wet/dry sizer (“COMIL”) and then vacuum-dried for 36 hours in an oven at 35° C. Hereby, toner particles (47) are prepared. The toner particles (47) have a volume average size of 6.0 μm.

With 100 parts of the toner particles (47), 2.0 parts of hydrophobic silica (“RY200” produced by Nippon Aerosil Co., Ltd.) is mixed using a Henschel mixer. Hereby, a toner (47) is prepared.

### Physical Properties

Table 1 lists the following properties of each of the toners prepared in Examples and Comparative Examples.
Median Sac [μm²] of areas Sa of Voronoi polygons
Standard deviation Ssd [μm²] of areas Sa of Voronoi polygons
Areas Sa [μm²] of Voronoi polygons formed by Voronoi division using the geometric centers of the vinyl resin particles as generatrices
Volume average size D50v of internal additive resin particles (vinyl resin particles and rubber particles)
Glass transition temperature Tg of internal additive resin particles (vinyl resin particles and rubber particles)
Length Lout of the portion of outline of the toner particles which overlaps the internal additive resin particles (vinyl resin particles, etc.), that is, the ratio of the length of a portion of the outline of the toner particles which overlaps the internal additive resin particles (vinyl resin particles, etc.) to the length of the outline of the toner particles.
The average equivalent circle diameter Dce of the internal additive resin particles (vinyl resin particles and rubber particles)
The proportion Wa(B) [mol %] of a structural unit derived from (meth)acrylate in the entire styrene-(meth)acrylate copolymer particles (St/Ac) used as internal additive resin particles
The proportion Wa(S) [mol %] of a structural unit derived from (meth)acrylate in the surfaces of the styrene-(meth)acrylate copolymer particles (St/Ac) used as internal additive resin particles
The proportion Ws(B) [mol %] of a structural unit derived from styrene in the entire styrene-(meth)acrylate copolymer particles (St/Ac) used as internal additive resin particles
The proportion Ws(S) [mol %] of a structural unit derived from styrene in the surfaces of the styrene-(meth)acrylate copolymer particles (St/Ac) used as internal additive resin particles
The solubility parameter SP(sa) of the surfaces of the internal additive resin particles (vinyl resin particles and rubber particles)
The solubility parameter SP(ap) of the binder resin (amorphous polyester resin)
The proportion of isophthalic acid to polyvalent carboxylic acid in the amorphous polyester resin (IPA ratio)

### Evaluations

### Preparation of Developers

Developers are each prepared by mixing 8 parts of one of the toners prepared in Examples with 100 parts of the carrier prepared in the following manner.

### Preparation of Carrier

Ferrite particles (average particle size: 50 μm): 100 parts
Toluene: 14 parts
Styrene/methyl methacrylate copolymer (copolymerization ratio: 15/85): 3 parts
Carbon black: 0.2 parts

The above components except the ferrite particles are dispersed with a sand mill to form a dispersion liquid. The dispersion liquid and the ferrite particles are charged into a degassing vacuum kneader. Then, while stirring is performed, the pressure is reduced and drying is performed. Hereby, a carrier is prepared.

### Retention of Fine-Line Resolution

A developer including one of the toners prepared in Examples and Comparative Examples is charged into the developing device of a color printer “ApeosPrint C5570” (produced by FUJIFILM Business Innovation Corp.).

The color copying machine is left to stand for 12 hours in a high temperature, high-humidity environment (28° C. and 85% RH).

Subsequently, an image including fine lines that have a width of 20 μm and are arranged at intervals of 3 cm is formed on A4-size sheets in the high-humidity environment (28° C. and 85% RH) using the color copying machine. After 500,000 sheets have been printed, the conditions of the fine lines are inspected and evaluated in accordance with the following criteria.
A: Blurring of the fine lines is not confirmed even when the fine lines are inspected with a loupe at a 100-fold magnification (acceptable range)
B: Medium between A and C (acceptable range)
C: Slight blurring of the fine lines is confirmed in some of the fine lines when the fine lines are inspected with a loupe at a 100-fold magnification (acceptable range)
D: Medium between C and E (acceptable range)
E: Slight blurring of the fine lines is confirmed all over the fine lines when the fine lines are inspected with a loupe at a 100-fold magnification (acceptable range)
F: Slight blurring of the fine lines is visually confirmed all over the fine lines (acceptable range)
G: Distinct blurring of the fine lines is visually confirmed all over the fine lines (unacceptable)

Table 1 lists the results obtained in Examples and Comparative Examples.

In Table 1, the term “Proportion of Amo in shell layer” refers to the proportion [% by mass] of the amorphous resin included in the shell layer to the toner particles.

TABLE 1

| | | | | | | | Proportion of |
|---|---|---|---|---|---|---|---|
| | | | Amorphous resin particle dispersion liquid | | | Crystalline resin | Amo in shell |
| | | Production | | IPA ratio | | particle | layer |
| | | method | Type | molar % | SP(ap) | dispersion liquid | mass % |
| Example 1 | Toner 1 | EA | Amo1 (with IPA) | 30 | 10.5 | Cry1 | 28 |
| Example 2 | Toner 2 | EA | Amo1 (with IPA) | 30 | 10.5 | Cry1 | 28 |
| Example 3 | Toner 3 | EA | Amo1 (with IPA) | 30 | 10.5 | Cry1 | 28 |
| Example 4 | Toner 4 | EA | Amo1 (with IPA) | 30 | 10.5 | Cry1 | 28 |
| Example 5 | Toner 5 | EA | Amo1 (with IPA) | 30 | 10.5 | Cry1 | 28 |
| Example 6 | Toner 6 | EA | Amo1 (with IPA) | 30 | 10.5 | Cry1 | 28 |
| Example 7 | Toner 7 | EA | Amo1 (with IPA) | 30 | 10.5 | Cry1 | 28 |
| Example 8 | Toner 8 | EA | Amo1 (with IPA) | 30 | 10.5 | Cry1 | 28 |
| Example 9 | Toner 9 | EA | Amo1 (with IPA) | 30 | 10.5 | Cry1 | 28 |
| Example 10 | Toner 10 | EA | Amo1 (with IPA) | 30 | 10.5 | Cry1 | 28 |
| Example 11 | Toner 11 | EA | Amo1 (with IPA) | 30 | 10.5 | Cry1 | 28 |
| Example 12 | Toner 12 | EA | Amo1 (with IPA) | 30 | 10.5 | Cry1 | 28 |
| Example 13 | Toner 13 | EA | Amo1 (with IPA) | 30 | 10.5 | Cry1 | 28 |
| Example 14 | Toner 14 | EA | Amo1 (with IPA) | 30 | 10.5 | — | 28 |
| Example 15 | Toner 15 | EA | Amo1 (with IPA) | 30 | 10.5 | Cry1 | 14 |
| Example 16 | Toner 16 | EA | Amo1 (with IPA) | 30 | 10.5 | Cry1 | 8 |
| Example 17 | Toner 17 | EA | Amo1 (with IPA) | 30 | 10.5 | Cry1 | 28 |
| Example 18 | Toner 18 | EA | Amo1 (with IPA) | 30 | 10.5 | Cry1 | 28 |
| Example 19 | Toner 19 | EA | Amo1 (with IPA) | 30 | 10.5 | Cry1 | 28 |
| Example 20 | Toner 20 | EA | Amo2 (without IPA) | 0 | 10.5 | Cry1 | 28 |
| Example 21 | Toner 21 | EA | Amo1 (with IPA) | 30 | 10.5 | Cry1 | 28 |
| Example 22 | Toner 22 | EA | Amo1 (with IPA) | 30 | 10.5 | Cry1 | 28 |
| Example 23 | Toner 23 | EA | Amo3 (high IPA content) | 46 | 10.5 | Cry1 | 28 |
| Example 24 | Toner 24 | EA | Amo4 (high IPA content) | 52 | 10.5 | Cry1 | 28 |
| Example 25 | Toner 25 | EA | Amo5 (low IPA content) | 12 | 10.5 | Cry1 | 28 |
| Example 26 | Toner 26 | EA | Amo1 (with IPA) | 30 | 10.5 | Cry1 | 28 |
| Example 27 | Toner 27 | EA | Amo1 (with IPA) | 30 | 10.5 | Cry1 | 28 |
| Example 28 | Toner 28 | EA | Amo1 (with IPA) | 30 | 10.5 | Cry1 | 28 |
| Example 29 | Toner 29 | EA | Amo1 (with IPA) | 30 | 10.5 | Cry1 | 28 |
| Example 30 | Toner 30 | EA | Amo1 (with IPA) | 30 | 10.5 | Cry1 | 28 |
| Example 31 | Toner 31 | EA | Amo1 (with IPA) | 30 | 10.5 | Cry1 | 28 |
| Example 32 | Toner 32 | EA | Amo1 (with IPA) | 30 | 10.5 | Cry1 | 28 |
| Example 33 | Toner 33 | EA | Amo1 (with IPA) | 30 | 10.5 | Cry1 | 28 |
| Example 34 | Toner 34 | EA | Amo1 (with IPA) | 30 | 10.5 | Cry1 | 28 |
| Example 35 | Toner 35 | EA | Amo1 (with IPA) | 30 | 10.5 | Cry1 | 28 |
| Example 36 | Toner 36 | EA | Amo1 (with IPA) | 30 | 10.5 | Cry1 | 28 |
| Example 37 | Toner 37 | EA | Amo1 (with IPA) | 30 | 10.5 | Cry1 | 28 |
| Example 38 | Toner 38 | EA | Amo1 (with IPA) | 30 | 10.5 | Cry1 | 28 |
| Example 39 | Toner 39 | EA | Amo1 (with IPA) | 30 | 10.5 | Cry1 | 28 |
| Example 40 | Toner 40 | EA | Amo1 (with IPA) | 30 | 10.5 | Cry1 | 28 |
| Example 41 | Toner 41 | EA | Amo1 (with IPA) | 30 | 10.5 | Cry1 | 28 |
| Example 42 | Toner 42 | EA | Amo6 (with IPA, high SP) | 30 | 11 | Cry1 | 28 |
| Comparative example 1 | Toner 43 | EA | Amo1 (with IPA) | 30 | 10.5 | Cry1 | 28 |
| Comparative example 2 | Toner 44 | EA | Amo1 (with IPA) | 30 | 10.5 | Cry1 | 28 |
| Comparative example 3 | Toner 45 | EA | Amo1 (with IPA) | 30 | 10.5 | Cry1 | 28 |
| Comparative example 4 | Toner 46 | EA | Amo1 (with IPA) | 30 | 10.5 | Cry1 | 28 |
| Comparative example 5 | Toner 47 | EA | Amo7 | 0 | 10.4 | Cry2 | 28 |

| | Internal additive resin particle dispersion liquid | | | |
|---|---|---|---|---|
| | | Content (vs | Colorant | Release agent |
| | | toner particles) | dispersion | dispersion |
| | Type (surface condition/presence of crosslinks/D50v/Tg) | mass % | liquid | liquid |
| Example 1 | Vinyl1(uneven distribution of BA/Yes/165 nm/Tg 17° C.) | 10 | Cyan1 | WAX1 |
| Example 2 | Vinyl2(uneven distribution of BA/Yes/100 nm/Tg 17° C.) | 10 | Cyan1 | WAX1 |
| Example 3 | Vinyl3(uneven distribution of BA/Yes/200 nm/Tg 17° C.) | 5 | Cyan1 | WAX1 |
| Example 4 | Vinyl4(uneven distribution of BA/Yes/300 nm/Tg 17° C.) | 16 | Cyan1 | WAX1 |
| Example 5 | Vinyl5(uneven distribution of BA/Yes/165 nm/Tg 1° C.) | 10 | Cyan1 | WAX1 |
| Example 6 | Vinyl6(uneven distribution of BA/Yes/165 nm/Tg 29° C.) | 10 | Cyan1 | WAX1 |
| Example 7 | Vinyl3(uneven distribution of BA/Yes/200 nm/Tg 17° C.) | 19 | Cyan1 | WAX1 |
| Example 8 | Vinyl7(uneven distribution of BA/Yes/310 nm/Tg 17° C.) | 18 | Cyan1 | WAX1 |
| Example 9 | Vinyl8(uneven distribution of BA/Yes/90 nm/Tg 17° C.) | 8 | Cyan1 | WAX1 |
| Example 10 | Vinyl1(uneven distribution of BA/Yes/165 nm/Tg 17° C.) | 4.3 | Cyan1 | WAX1 |
| Example 11 | Vinyl3(uneven distribution of BA/Yes/200 nm/Tg 17° C.) | 20 | Cyan1 | WAX1 |
| Example 12 | Vinyl9(uneven distribution of BA/Yes/165 nm/Tg 32° C.) | 10 | Cyan1 | WAX1 |
| Example 13 | Vinyl10(uneven distribution of BA/Yes/165 nm/Tg −5° C.) | 10 | Cyan1 | WAX1 |
| Example 14 | Vinyl1(uneven distribution of BA/Yes/165 nm/Tg 17° C.) | 10 | Cyan1 | WAX1 |
| Example 15 | Vinyl1(uneven distribution of BA/Yes/165 nm/Tg 17° C.) | 10 | Cyan1 | WAX1 |
| Example 16 | Vinyl1(uneven distribution of BA/Yes/165 nm/Tg 17° C.) | 10 | Cyan1 | WAX1 |
| Example 17 | Vinyl1(uneven distribution of BA/Yes/165 nm/Tg 17° C.) | 10 | Cyan1 | WAX1 |
| Example 18 | Vinyl4(uneven distribution of BA/Yes/300 nm/Tg 17° C.) | 10 | Cyan1 | WAX1 |
| Example 19 | Vinyl1(uneven distribution of BA/Yes/165 nm/Tg 17° C.) | 10 | Black1 | WAX1 |
| Example 20 | Vinyl1(uneven distribution of BA/Yes/165 nm/Tg 17° C.) | 10 | Cyan1 | WAX1 |
| Example 21 | Vinyl11(uneven distribution of BA/No/165 nm/Tg 17° C.) | 10 | Cyan1 | WAX1 |
| Example 22 | Vinyl12(uneven distribution of St/Yes/165 nm/Tg 17° C.) | 10 | Cyan1 | WAX1 |
| Example 23 | Vinyl1(uneven distribution of BA/Yes/165 nm/Tg 17° C.) | 10 | Cyan1 | WAX1 |
| Example 24 | Vinyl1(uneven distribution of BA/Yes/165 nm/Tg 17° C.) | 10 | Cyan1 | WAX1 |
| Example 25 | Vinyl1(uneven distribution of BA/Yes/165 nm/Tg 17° C.) | 10 | Cyan1 | WAX1 |
| Example 26 | Vinyl13(uneven distribution of BA/Yes/164 nm/Tg 15° C./) | 10 | Cyan1 | WAX1 |
| Example 27 | Vinyl14(uneven distribution of BA/Yes/166 nm/Tg 17° C./) | 10 | Cyan1 | WAX1 |
| Example 28 | Vinyl15(uneven distribution of BA/Yes/165 nm/Tg 17° C./) | 10 | Cyan1 | WAX1 |
| Example 29 | Vinyl16(uneven distribution of BA/Yes/165 nm/Tg 17° C./) | 10 | Cyan1 | WAX1 |
| Example 30 | Vinyl17(uneven distribution of BA/Yes/165 nm/Tg 18° C./) | 10 | Cyan1 | WAX1 |
| Example 31 | Vinyl18(uneven distribution of BA/Yes/166 nm/Tg 18° C./) | 10 | Cyan1 | WAX1 |
| Example 32 | Vinyl19(uneven distribution of BA/Yes/167 nm/Tg 18° C./) | 10 | Cyan1 | WAX1 |
| Example 33 | Vinyl20(uneven distribution of BA/Yes/165 nm/Tg 18° C./) | 10 | Cyan1 | WAX1 |
| Example 34 | Vinyl21(uneven distribution of BA/Yes/163 nm/Tg 17° C./) | 10 | Cyan1 | WAX1 |
| Example 35 | Vinyl22(uneven distribution of St/Yes/167 nm/Tg 17° C./) | 10 | Cyan1 | WAX1 |
| Example 36 | Vinyl23(uneven distribution of St/Yes/165 nm/Tg 17° C./) | 10 | Cyan1 | WAX1 |
| Example 37 | Vinyl24(uneven distribution of St/Yes/164 nm/Tg 12° C./) | 10 | Cyan1 | WAX1 |
| Example 38 | Vinyl25(uneven distribution of St/Yes/166 nm/Tg 18° C./) | 10 | Cyan1 | WAX1 |
| Example 39 | Vinyl26(uneven distribution of St/Yes/165 nm/Tg 18° C./) | 10 | Cyan1 | WAX1 |
| Example 40 | Vinyl27(uneven distribution of St/Yes/164 nm/Tg 18° C./) | 10 | Cyan1 | WAX1 |
| Example 41 | Vinyl28(uneven distribution of St/Yes/166 nm/Tg 18° C./) | 10 | Cyan1 | WAX1 |
| Example 42 | Vinyl1(uneven distribution of BA/Yes/165 nm/Tg 17° C.) | 10 | Cyan1 | WAX1 |
| Comparative example 1 | Vinyl29(uneven distribution of BA/Yes/120 nm/Tg 15° C.) | 18.5 | Cyan1 | WAX1 |
| Comparative example 2 | Vinyl29(uneven distribution of BA/Yes/120 nm/Tg 15° C.) | 9.5 | Cyan1 | WAX1 |
| Comparative example 3 | Vinyl1(uneven distribution of BA/Yes/165 nm/Tg 17° C.) | 10 | Cyan1 | WAX1 |
| Comparative example 4 | Rubber1(—/Yes/180 nm/−20° C.) | 10 | Cyan1 | WAX1 |
| Comparative example 5 | Vinyl30(St:BA = 77:23/slight/62 nm/Tg 60.8° C.) | | Black2 | WAX2 |

| | Voronoi polygon | | | | | | | | |
|---|---|---|---|---|---|---|---|---|---|
| | Median | Standard deviation | Area | Internal additive resin particles | | | | | |
| | Sac | Ssd | Sa | D50v | Tg | Overlap | | Dce | |
| | μm2 | μm2 | μm2 | nm | ° C. | proportion | Lout | nm | Dce − D50v |
| Example 1 | 0.12 | 0.06 | 0.26 | 165 | 17 | 25 | 3.2 | 194 | 29 |
| Example 2 | 0.03 | 0.02 | 0.26 | 100 | 17 | 28 | 3 | 149 | 49 |
| Example 3 | 0.19 | 0.09 | 0.16 | 200 | 17 | 36.4 | 2.2 | 242 | 42 |
| Example 4 | 0.20 | 0.09 | 0.356 | 300 | 17 | 40.2 | 3.4 | 340 | 40 |
| Example 5 | 0.12 | 0.06 | 0.26 | 165 | 1 | 35.8 | 3.3 | 199 | 34 |
| Example 6 | 0.12 | 0.06 | 0.26 | 165 | 29 | 32.3 | 3 | 202 | 37 |
| Example 7 | 0.08 | 0.04 | 0.399 | 200 | 17 | 34.5 | 2.1 | 238 | 38 |
| Example 8 | 0.20 | 0.09 | 0.385 | 310 | 17 | 39.8 | 2.2 | 360 | 50 |
| Example 9 | 0.03 | 0.02 | 0.22 | 90 | 17 | 32.5 | 2.3 | 143 | 53 |
| Example 10 | 0.16 | 0.06 | 0.15 | 165 | 17 | 34.6 | 2 | 201 | 36 |
| Example 11 | 0.08 | 0.06 | 0.42 | 200 | 17 | 32.5 | 3.9 | 232 | 32 |
| Example 12 | 0.12 | 0.06 | 0.26 | 165 | 32 | 34.3 | 2.3 | 201 | 36 |
| Example 13 | 0.12 | 0.06 | 0.26 | 165 | −5 | 35.6 | 2.4 | 204 | 39 |
| Example 14 | 0.12 | 0.06 | 0.26 | 165 | 17 | 29.9 | 2.1 | 199 | 34 |
| Example 15 | 0.12 | 0.06 | 0.26 | 165 | 17 | 33.9 | 4.8 | 201 | 36 |
| Example 16 | 0.12 | 0.06 | 0.26 | 165 | 17 | 34.3 | 10.2 | 202 | 37 |
| Example 17 | 0.14 | 0.07 | 0.26 | 165 | 17 | 47.9 | 3.4 | 280 | 115 |
| Example 18 | 0.20 | 0.10 | 0.356 | 300 | 17 | 60.8 | 3.2 | 410 | 110 |
| Example 19 | 0.12 | 0.06 | 0.26 | 165 | 17 | 26.5 | 3.2 | 201 | 36 |
| Example 20 | 0.18 | 0.08 | 0.26 | 165 | 17 | 46.5 | 3.2 | 201 | 36 |
| Example 21 | 0.12 | 0.06 | 0.26 | 165 | 17 | Fusion | 3.2 | 290 | 125 |
| Example 22 | 0.12 | 0.06 | 0.26 | 165 | 17 | 24 | 3.2 | 201 | 36 |
| Example 23 | 0.14 | 0.07 | 0.26 | 165 | 17 | 38 | 3.2 | 250 | 85 |
| Example 24 | 0.18 | 0.08 | 0.26 | 165 | 17 | 46 | 3.2 | 290 | 125 |
| Example 25 | 0.14 | 0.07 | 0.26 | 165 | 17 | 38 | 3.2 | 240 | 75 |
| Example 26 | 0.13 | 0.06 | 0.25 | 164 | 15 | 24 | 3.1 | 200 | 36 |
| Example 27 | 0.12 | 0.06 | 0.26 | 166 | 17 | 34 | 3.3 | 193 | 27 |
| Example 28 | 0.13 | 0.06 | 0.26 | 165 | 17 | 33 | 3.2 | 196 | 31 |
| Example 29 | 0.13 | 0.07 | 0.26 | 165 | 17 | 34 | 3.4 | 210 | 45 |
| Example 30 | 0.12 | 0.07 | 0.27 | 165 | 18 | 28 | 3.2 | 195 | 30 |
| Example 31 | 0.13 | 0.06 | 0.27 | 166 | 18 | 34 | 3.3 | 194 | 28 |
| Example 32 | 0.12 | 0.06 | 0.26 | 167 | 18 | 26 | 3.1 | 205 | 38 |
| Example 33 | 0.13 | 0.06 | 0.26 | 165 | 18 | 35 | 3.2 | 211 | 46 |
| Example 34 | 0.12 | 0.07 | 0.27 | 163 | 17 | 23 | 3.2 | 195 | 32 |
| Example 35 | 0.13 | 0.06 | 0.27 | 167 | 17 | 25 | 3.2 | 199 | 32 |
| Example 36 | 0.12 | 0.06 | 0.26 | 165 | 17 | 27 | 3.1 | 193 | 28 |
| Example 37 | 0.13 | 0.06 | 0.26 | 164 | 12 | 26 | 3.3 | 198 | 34 |
| Example 38 | 0.13 | 0.06 | 0.26 | 166 | 18 | 27 | 3.4 | 195 | 29 |
| Example 39 | 0.13 | 0.07 | 0.27 | 165 | 18 | 28 | 3.2 | 202 | 37 |
| Example 40 | 0.12 | 0.06 | 0.27 | 164 | 18 | 26 | 3.2 | 185 | 21 |
| Example 41 | 0.13 | 0.06 | 0.26 | 166 | 18 | 25 | 3.3 | 201 | 35 |
| Example 42 | 0.17 | 0.09 | 0.27 | 165 | 17 | 36 | 3.2 | 240 | 75 |
| Comparative example 1 | 0.02 | 0.06 | 0.394 | 120 | 15 | 24 | 3.2 | 150 | 30 |
| Comparative example 2 | 0.21 | 0.06 | 0.151 | 120 | 15 | 20.3 | 2.9 | 200 | 80 |
| Comparative example 3 | 0.19 | 0.18 | 0.26 | 165 | 17 | 60 | 3.3 | 240 | 75 |

| | Internal additive resin particles | | | | | |
|---|---|---|---|---|---|---|
| | St/Ac | St/Ac | St/Ac | St/Ac | St/Ac | St/Ac |
| | Wa(B) | Wa(S) | Wa(S) − Wa(B) | Ws(B) | Ws(S) | Ws(S) − Ws(B) |
| | molar % | molar % | molar % | molar % | molar % | molar % |
| Example 1 | 43.61 | 53.77 | 10.15 | 55.77 | 45.60 | −10.17 |
| Example 2 | 43.61 | 53.77 | 10.15 | 55.77 | 45.60 | −10.17 |
| Example 3 | 43.61 | 53.77 | 10.15 | 55.77 | 45.60 | −10.17 |
| Example 4 | 43.61 | 53.77 | 10.15 | 55.77 | 45.60 | −10.17 |
| Example 5 | 54.09 | 62.49 | 8.40 | 45.28 | 36.87 | −8.41 |
| Example 6 | 37.13 | 48.33 | 11.21 | 62.27 | 51.04 | −11.22 |
| Example 7 | 43.61 | 53.77 | 10.15 | 55.77 | 45.60 | −10.17 |
| Example 8 | 43.61 | 53.77 | 10.15 | 55.77 | 45.60 | −10.17 |
| Example 9 | 43.61 | 53.77 | 10.15 | 55.77 | 45.60 | −10.17 |
| Example 10 | 43.61 | 53.77 | 10.15 | 55.77 | 45.60 | −10.17 |
| Example 11 | 43.61 | 53.77 | 10.15 | 55.77 | 45.60 | −10.17 |
| Example 12 | 35.38 | 46.86 | 11.48 | 64.01 | 52.51 | −11.50 |
| Example 13 | 57.89 | 65.89 | 8.00 | 41.47 | 33.46 | −8.01 |
| Example 14 | 43.61 | 53.77 | 10.15 | 55.77 | 45.60 | −10.17 |
| Example 15 | 43.61 | 53.77 | 10.15 | 55.77 | 45.60 | −10.17 |
| Example 16 | 43.61 | 53.77 | 10.15 | 55.77 | 45.60 | −10.17 |
| Example 17 | 43.61 | 53.77 | 10.15 | 55.77 | 45.60 | −10.17 |
| Example 18 | 43.61 | 53.77 | 10.15 | 55.77 | 45.60 | −10.17 |
| Example 19 | 43.61 | 53.77 | 10.15 | 55.77 | 45.60 | −10.17 |
| Example 20 | 43.61 | 53.77 | 10.15 | 55.77 | 45.60 | −10.17 |
| Example 21 | 43.88 | 54.11 | 10.23 | 56.12 | 45.89 | −10.23 |
| Example 22 | 43.61 | 33.89 | −9.72 | 55.77 | 65.51 | 9.74 |
| Example 23 | 43.61 | 53.77 | 10.15 | 55.77 | 45.60 | −10.17 |
| Example 24 | 43.61 | 53.77 | 10.15 | 55.77 | 45.60 | −10.17 |
| Example 25 | 43.61 | 53.77 | 10.15 | 55.77 | 45.60 | −10.17 |
| Example 26 | 45.45 | 46.45 | 1.00 | 53.93 | 52.93 | −1.00 |
| Example 27 | 43.61 | 46.61 | 3.00 | 55.77 | 52.77 | −3.00 |
| Example 28 | 43.61 | 61.61 | 18.00 | 55.77 | 37.75 | −18.02 |
| Example 29 | 43.61 | 65.61 | 22.00 | 55.77 | 33.74 | −22.03 |
| Example 30 | 43.64 | 38.00 | −5.64 | 55.74 | 61.39 | 5.65 |
| Example 31 | 43.64 | 42.00 | −1.64 | 55.74 | 57.38 | 1.64 |
| Example 32 | 43.64 | 77.00 | 33.36 | 55.74 | 22.34 | −33.40 |
| Example 33 | 43.64247 | 82.00 | 38.36 | 55.74 | 17.33 | −38.41 |
| Example 34 | 43.61 | 42.61 | −1.00 | 55.77 | 56.77 | 1.00 |
| Example 35 | 43.61 | 40.62 | −3.00 | 55.77 | 58.77 | 3.00 |
| Example 36 | 43.61 | 25.64 | −17.98 | 55.77 | 73.77 | 18.00 |
| Example 37 | 47.28 | 25.31 | −21.97 | 52.10 | 74.10 | 22.00 |
| Example 38 | 43.64 | 61.36 | 17.72 | 55.74 | 38.00 | −17.74 |
| Example 39 | 43.64 | 57.36 | 13.72 | 55.74 | 42.00 | −13.74 |
| Example 40 | 43.64 | 22.41 | −21.23 | 55.74 | 77.00 | 21.26 |
| Example 41 | 43.64 | 17.42 | −26.22 | 55.74 | 82.00 | 26.26 |
| Example 42 | 43.61 | 53.77 | 10.15 | 55.77 | 45.60 | −10.17 |
| Comparative example 1 | 43.61 | 53.77 | 10.15 | 55.77 | 45.60 | −10.17 |
| Comparative example 2 | 43.61 | 53.77 | 10.15 | 55.77 | 45.60 | −10.17 |
| Comparative example 3 | 43.61 | 53.77 | 10.15 | 55.77 | 45.60 | −10.17 |
| Comparative example 4 | — | — | — | — | — | — |
| Comparative example 5 | 19.31 | 19.31 | 0.00 | 80.17 | 80.17 | 0 |

| | | | | Evaluation |
|---|---|---|---|---|
| | Internal additive resin particles | | | Fine-line retention |
| | Presence of crosslinks | SP(sa) | \|SP(ap) − SP(sa)\| | 500,000 sheets (ultralong term) |
| Example 1 | Yes | 9.93 | 0.57 | A |
| Example 2 | Yes | 9.93 | 0.57 | B |
| Example 3 | Yes | 9.93 | 0.57 | B |
| Example 4 | Yes | 9.93 | 0.57 | C |
| Example 5 | Yes | 9.87 | 0.63 | C |
| Example 6 | Yes | 9.97 | 0.53 | C |
| Example 7 | Yes | 9.93 | 0.57 | C |
| Example 8 | Yes | 9.93 | 0.57 | E |
| Example 9 | Yes | 9.93 | 0.57 | E |
| Example 10 | Yes | 9.93 | 0.57 | D |
| Example 11 | Yes | 9.93 | 0.57 | D |
| Example 12 | Yes | 9.98 | 0.52 | D |
| Example 13 | Yes | 9.85 | 0.65 | E |
| Example 14 | Yes | 9.93 | 0.57 | A |
| Example 15 | Yes | 9.93 | 0.57 | B |
| Example 16 | Yes | 9.93 | 0.57 | D |
| Example 17 | Yes | 9.93 | 0.57 | D |
| Example 18 | Yes | 9.93 | 0.57 | F |
| Example 19 | Yes | 9.93 | 0.57 | A |
| Example 20 | Yes | 9.93 | 0.57 | F |
| Example 21 | No | 9.93 | 0.57 | D |
| Example 22 | Yes | 10.07 | 0.43 | A |
| Example 23 | Yes | 9.93 | 0.57 | B |
| Example 24 | Yes | 9.93 | 0.57 | D |
| Example 25 | Yes | 9.93 | 0.57 | B |
| Example 26 | Yes | 9.98 | 0.52 | D |
| Example 27 | Yes | 9.98 | 0.52 | B |
| Example 28 | Yes | 9.88 | 0.62 | C |
| Example 29 | Yes | 9.85 | 0.65 | E |
| Example 30 | Yes | 10.04 | 0.46 | A |
| Example 31 | Yes | 10.02 | 0.48 | A |
| Example 32 | Yes | 9.77 | 0.73 | E |
| Example 33 | Yes | 9.73 | 0.77 | F |
| Example 34 | Yes | 10.01 | 0.49 | D |
| Example 35 | Yes | 10.03 | 0.47 | B |
| Example 36 | Yes | 10.13 | 0.37 | B |
| Example 37 | Yes | 10.16 | 0.34 | D |
| Example 38 | Yes | 9.88 | 0.62 | A |
| Example 39 | Yes | 9.91 | 0.59 | A |
| Example 40 | Yes | 10.15 | 0.35 | E |
| Example 41 | Yes | 10.19 | 0.31 | F |
| Example 42 | Yes | 9.93 | 1.07 | F |
| Comparative example 1 | Yes | 10.00 | 0.50 | G |
| Comparative example 2 | Yes | 10.00 | 0.50 | G |
| Comparative example 3 | Yes | 9.93 | 0.57 | G |
| Comparative example 4 | Yes | 8.4 | 2.10 | G |
| Comparative example 5 | Slight | 10.2 | 0.20 | G |

The above results confirm that the toners prepared in Examples are suitable in terms of the retention of fine-line resolution in a high temperature, high-humidity environment, compared with the toners prepared in Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An electrostatic image developing toner comprising toner particles including:
a binder resin; and
vinyl resin particles,
wherein, when a cross section of the toner particles is observed and areas Sa [μm²] of Voronoi polygons obtained by Voronoi division of the cross section using geometric centers of the vinyl resin particles as generatrices are measured, Formulae (1) and (2) are satisfied:

$$0.03 \leq Sac \leq 0.2 \qquad ( 1 )$$

$$Ssd \leq 0.1 \qquad ( 2 )$$

where Sac and Ssd represent a median [μm²] and a standard deviation [μm²] of the areas Sa of the Voronoi polygons, respectively.

(((2)))

The electrostatic image developing toner according to (((1))),
wherein Formula (11) is satisfied:

$$0.08 \leq Sac \leq 0.16 \qquad ( 11 )$$

(((3)))

The electrostatic image developing toner according to (((1))) or (((2))),
wherein Formula (21) is satisfied:

$$Ssd \leq 0. 7 \qquad ( 21 )$$

(((4)))

The electrostatic image developing toner according to any one of (((1))) to (((3))),
wherein, in the observation of the cross section of the toner particles, a ratio of an area of the vinyl resin particles to an area of the toner particles is more than 0.15 and 0.40 or less.

(((5)))

The electrostatic image developing toner according to any one of (((1))) to (((4))),
wherein the vinyl resin particles have a volume average size of 100 nm or more and 300 nm or less.

(((6)))

The electrostatic image developing toner according to any one of (((1))) to (((5))),
wherein the vinyl resin particles have a glass transition temperature of 0° C. or more and 30° C. or less.

(((7)))

The electrostatic image developing toner according to any one of (((1))) to (((6))),
wherein, in the observation of the cross section of the toner particles, the number of a part of the vinyl resin particles, the part being vinyl resin particles appearing to overlap one another, is 50 number % or less of the total number of the vinyl resin particles observed.

(((8)))

The electrostatic image developing toner according to any one of (((1))) to (((7))),
wherein, in the observation of the cross section of the toner particles, a length of a part of an outline of the toner particles, the part overlapping the vinyl resin particles, is 5% or less of a length of the outline of the toner particles.

(((9)))

The electrostatic image developing toner according to any one of (((1))) to (((8))),
wherein, in the observation of the cross section of the toner particles, the vinyl resin particles observed have an average equivalent circle diameter of 400 nm or less.

(((10)))

The electrostatic image developing toner according to any one of (((1))) to (((9))),
wherein the vinyl resin particles are styrene-(meth)acrylate copolymer particles, and
a proportion Wa(B) [mol %] of a structural unit derived from (meth)acrylate in the entire styrene-(meth)acrylate copolymer particles and a proportion Wa(S) [mol %] of the structural unit derived from (meth)acrylate in surfaces of the styrene-(meth)acrylate copolymer particles satisfy relationship below:

$$2 \leq Wa ( S ) - Wa ( B ) \leq 20 .$$

(((11)))

The electrostatic image developing toner according to (((10))),
wherein the proportion Wa(S) [mol %] of the structural unit derived from (meth)acrylate in the surfaces of the styrene-(meth)acrylate copolymer particles satisfies:

$$40 \leq Wa ( S ) \leq 80 .$$

(((12)))

The electrostatic image developing toner according to any one of (((1))) to (((9))),
wherein the vinyl resin particles are styrene-(meth)acrylate copolymer particles, and
a proportion Ws(B) [mol %] of a structural unit derived from styrene in the entire styrene-(meth)acrylate copolymer particles and a proportion Ws(S) [mol %] of the structural unit derived from styrene in surfaces of the styrene-(meth)acrylate copolymer particles satisfy relationship below:

$$2 \leq Ws ( S ) - Ws ( B ) \leq 20.$$

(((13)))

The electrostatic image developing toner according to (((12))),
wherein the proportion Ws(S) [mol %] of the structural unit derived from styrene in the surfaces of the styrene-(meth)acrylate copolymer particles satisfies:

$$40 \leq Ws ( S ) \leq 80 .$$

(((14)))

The electrostatic image developing toner according to (((10))) or (((11))),
wherein a solubility parameter SP(sa) of surfaces of the vinyl resin particles and a solubility parameter SP(ap) of the binder resin satisfy a relationship below:

$$\vert SP ( ap ) - SP ( sa ) \vert \leq 1. .$$

(((15)))

The electrostatic image developing toner according to (((12))) or (((13))),
wherein a solubility parameter SP(sa) of surfaces of the vinyl resin particles and a solubility parameter SP(ap) of the binder resin satisfy a relationship below:

$$\vert SP ( ap ) - SP ( sa ) \vert \leq 1. .$$

(((16)))

The electrostatic image developing toner according to (((10))), (((11))), or (((14))),
wherein the binder resin includes an amorphous polyester resin,
the amorphous polyester resin is composed of a condensation polymer of a polyvalent carboxylic acid including isophthalic acid and a polyhydric alcohol, and
a proportion of the isophthalic acid to the polyvalent carboxylic acid is 10 mol % or more and 50 mol % or less.

(((17)))

The electrostatic image developing toner according to (((12))), (((13))), or (((15))),
wherein the binder resin includes an amorphous polyester resin,
the amorphous polyester resin is composed of a condensation polymer of a polyvalent carboxylic acid including isophthalic acid and a polyhydric alcohol, and
a proportion of the isophthalic acid to the polyvalent carboxylic acid is 10 mol % or more and 50 mol % or less.

(((18)))

The electrostatic image developing toner according to any one of (((1))) to (((17))), wherein the vinyl resin particles are resin particles having a crosslinked structure.

(((19)))

An electrostatic image developer comprising:
the electrostatic image developing toner according to any one of (((1))) to (((18))).

(((20)))

A toner cartridge detachably attachable to an image forming apparatus, the toner cartridge comprising:
the electrostatic image developing toner according to any one of (((1))) to (((18))).

(((21)))

A process cartridge detachably attachable to an image forming apparatus, the process cartridge comprising:
a developing unit that includes the electrostatic image developer according to (((19))) and develops an electrostatic image formed on a surface of an image holding member with the electrostatic image developer to form a toner image.

(((22)))

An image forming apparatus comprising:
an image holding member;
a charging unit that charges a surface of the image holding member;
an electrostatic image formation unit that forms an electrostatic image on the charged surface of the image holding member;
a developing unit that includes the electrostatic image developer according to (((19))) and develops the electrostatic image formed on the surface of the image holding member with the electrostatic image developer to form a toner image;
a transfer unit that transfers the toner image formed on the surface of the image holding member onto a surface of a recording medium; and a fixing unit that fixes the toner image transferred on the surface of the recording medium.

(((23)))

An image forming method comprising:
charging a surface of an image holding member;
forming an electrostatic image on the charged surface of the image holding member;
developing the electrostatic image formed on the surface of the image holding member with the electrostatic image developer according to (((19))) to form a toner image;
transferring the toner image formed on the surface of the image holding member onto a surface of a recording medium; and
fixing the toner image transferred onto the surface of the recording medium.

What is claimed is:

1. An electrostatic image developing toner comprising toner particles including:
a binder resin; and
vinyl resin particles,
wherein, when a cross section of the toner particles is observed and areas Sa [μm²] of Voronoi polygons obtained by Voronoi division of the cross section using geometric centers of the vinyl resin particles as generatrices are measured, Formulae (1) and (2) are satisfied:
$$0.03 \leq Sac \leq 0.2 \qquad ( 1 )$$
$$Ssd \leq 0.1 \qquad ( 2 )$$
where Sac and Ssd represent a median [μm²] and a standard deviation [μm²] of the areas Sa of the Voronoi polygons, respectively.

2. The electrostatic image developing toner according to claim 1,
wherein Formula (11) is satisfied:
$$0.08 \leq Sac \leq 0.16 \qquad ( 11 )$$

3. The electrostatic image developing toner according to claim 2,
wherein Formula (21) is satisfied:
$$Ssd \leq 0.07 \qquad ( 21 )$$

4. The electrostatic image developing toner according to claim 1,
wherein, in the observation of the cross section of the toner particles, a ratio of an area of the vinyl resin particles to an area of the toner particles is more than 0.15 and 0.40 or less.

5. The electrostatic image developing toner according to claim 1,
wherein the vinyl resin particles have a volume average size of 100 nm or more and 300 nm or less.

6. The electrostatic image developing toner according to claim 1,
wherein the vinyl resin particles have a glass transition temperature of 0° C. or more and 30° C. or less.

7. The electrostatic image developing toner according to claim 1,
wherein, in the observation of the cross section of the toner particles, the number of a part of the vinyl resin particles, the part being vinyl resin particles appearing to overlap one another, is 50 number % or less of the total number of the vinyl resin particles observed.

8. The electrostatic image developing toner according to claim 1,
wherein, in the observation of the cross section of the toner particles, a length of a part of an outline of the toner particles, the part overlapping the vinyl resin particles, is 5% or less of a length of the outline of the toner particles.

9. The electrostatic image developing toner according to claim 1,
wherein, in the observation of the cross section of the toner particles, the vinyl resin particles observed have an average equivalent circle diameter of 400 nm or less.

10. The electrostatic image developing toner according to claim 1,
wherein the vinyl resin particles are styrene-(meth)acrylate copolymer particles, and
a proportion Wa(B) [mol %] of a structural unit derived from (meth)acrylate in the entire styrene-(meth)acrylate copolymer particles and a proportion Wa(S) [mol %] of the structural unit derived from (meth)acrylate in surfaces of the styrene-(meth)acrylate copolymer particles satisfy relationship below:
$$2 \leq Wa ( S ) - Wa ( B ) \leq 20 .$$

11. The electrostatic image developing toner according to claim 10,
wherein the proportion Wa(S) [mol %] of the structural unit derived from (meth)acrylate in the surfaces of the styrene-(meth)acrylate copolymer particles satisfies:
$$40 \leq Wa ( S ) \leq 80 .$$

12. The electrostatic image developing toner according to claim 1,
wherein the vinyl resin particles are styrene-(meth)acrylate copolymer particles, and
a proportion Ws(B) [mol %] of a structural unit derived from styrene in the entire styrene-(meth)acrylate copolymer particles and a proportion Ws(S) [mol %] of the structural unit derived from styrene in surfaces of the styrene-(meth)acrylate copolymer particles satisfy relationship below:
$$2 \leq Ws ( S ) - Ws ( B ) \leq 20 .$$

13. The electrostatic image developing toner according to claim 12,
wherein the proportion Ws(S) [mol %] of the structural unit derived from styrene in the surfaces of the styrene-(meth)acrylate copolymer particles satisfies:
$$40 \leq Ws ( S ) \leq 80 .$$

14. The electrostatic image developing toner according to claim 10,
wherein a solubility parameter SP(sa) of surfaces of the vinyl resin particles and a solubility parameter SP(ap) of the binder resin satisfy a relationship below:
$$\vert SP ( ap ) - SP ( sa ) \vert \leq 1. .$$

15. The electrostatic image developing toner according to claim 12,
wherein a solubility parameter SP(sa) of surfaces of the vinyl resin particles and a solubility parameter SP(ap)_of the binder resin satisfy a relationship below:
$$\vert SP ( ap ) - SP ( sa ) \vert \leq 1. .$$

16. The electrostatic image developing toner according to claim 10,
wherein the binder resin includes an amorphous polyester resin,
the amorphous polyester resin is composed of a condensation polymer of a polyvalent carboxylic acid including isophthalic acid and a polyhydric alcohol, and
a proportion of the isophthalic acid to the polyvalent carboxylic acid is 10 mol % or more and 50 mol % or less.

17. The electrostatic image developing toner according to claim 12,
wherein the binder resin includes an amorphous polyester resin,
the amorphous polyester resin is composed of a condensation polymer of a polyvalent carboxylic acid including isophthalic acid and a polyhydric alcohol, and
a proportion of the isophthalic acid to the polyvalent carboxylic acid is 10 mol % or more and 50 mol % or less.

18. The electrostatic image developing toner according to claim 1,
wherein the vinyl resin particles are resin particles having a crosslinked structure.

19. An electrostatic image developer comprising:
the electrostatic image developing toner according to claim 1.

20. A toner cartridge detachably attachable to an image forming apparatus, the toner cartridge comprising:
the electrostatic image developing toner according to claim 1.
